(19) United States
(12) Patent Application Publication
(10) Pub. No.: US 2023/0140301 A1
(43) Pub. Date: May 4, 2023

(54) DOWN-FIRE GRAPHENE HEATING SYSTEM

(71) Applicant: Farrpro, Inc., Iowa City, IA (US)

(72) Inventors: Amos Issac Petersen, Iowa City, IA (US); Steven James Hoff, Iowa City, IA (US); Benjamin Carl Smith, Iowa City, IA (US); Cameron Jesse Smith, Iowa City, IA (US); James Donald Riley, Iowa City, IA (US)

(21) Appl. No.: 17/978,531

(22) Filed: Nov. 1, 2022

Related U.S. Application Data
(60) Provisional application No. 63/274,618, filed on Nov. 2, 2021.

(51) Int. Cl. A01K 1/00; H05B 3/14; H05B 3/36

(52) U.S. Cl. CPC A01K 1/0076; H05B 3/145; H05B 3/36; H05B 2203/032; H05B 2203/013

(57) ABSTRACT

In one or more arrangements, a heating system is provided having one or more heating panels positioned in a housing. The housing has a hollow interior with an open lower end. A first panel is positioned in the open lower end of the housing. The first heating panel includes a heating layer. The heating layer includes a conductive microfilm. A first electrical contact is connected to the conductive microfilm. A second electrical contact is connected to the conductive microfilm. In one or more arrangements, the conductive microfilm includes at least one layer of graphene or nanofiber carbon material. Application of a voltage difference between the first electrical contact and the second electrical contact causes current to flow through the conductive microfilm, thereby generating heat. In one or more arrangements, current which flows through the conductive microfilm causes the conductive microfilm to emit infrared radiation.

### PRIOR RELATED APPLICATIONS

This application claims priority to U.S. Provisional Patent Application No. 63/274,618 filed Nov. 2, 2021, and titled “DOWN-FIRE GRAPHENE HEATING SYSTEM”, which is hereby fully incorporated by reference herein.

### FIELD OF THE DISCLOSURE

This disclosure relates generally to heating systems. More specifically, and without limitation, this disclosure relates to livestock heating systems.

### OVERVIEW OF THE DISCLOSURE

Heating systems are used in modern agriculture to provide warmth for livestock in colder temperatures. For example, in farrowing of swine, it is frequently desirable to provide piglets with supplemental heat without overheating, and thereby stressing, the sow. However, due to their much higher surface area to volume ratios, more external heat needs to be applied to the piglets than to the sow to keep all of the animals at the optimum temperature. Failure to provide piglets with sufficient external heat may lead to the death of some piglets from chilling, starvation, and disease. While piglets may lie against the sow for warmth, this increases the chances of the sow rolling over and suffocating or crushing the piglets.

Some heating systems for farrowing provide a farrowing crate with separate sow and piglet areas separated by a fence. The piglet area is provided with a heat lamp and/or heat mat to draw the piglets away from the sow to avoid injury or death associated with crushing. Providing separate heating systems for the piglet area draws and warms the piglets without overheating the sow. The fence is provided with metal fingers or other barriers to allow the piglets to pass back and forth between the sow and piglet areas for feeding and heating, while preventing the sow from moving into the piglet area and crushing the piglets.

Some livestock heating systems utilize heat lamps to generate heat. However, heat lamps generally do not distribute heat uniformly but rather radiate heat isotropically, creating a heating pattern of concentric bands of heating that increase in temperature toward a point directly below the heat lamp. The heating pattern therefore presents a thermal gradient, with temperatures on the outer boundary of the heating pattern being too cold, thereby preventing piglets from receiving efficient heating, and the center of the heating pattern being too warm, potentially subjecting piglets to overheating and burns. Heat lamps therefore generate a net usable area between the center and outer boundary of the heating pattern, which may account for only twenty percent of the entire isotropic heating pattern, which, when combined with energy loss of the heat lamp, can translate into a heating efficiency of five percent or less as measured by received energy. Moreover, any unused heat converts into waste heat that may need to be vented from the farrowing area to prevent nearby sows from overheating.

Heat lamps may also present a high risk of fire. For example, heating lamps typically utilize halogen or other heating elements that reach very high temperatures during operation. Such temperatures may cause nearby objects to inadvertently catch fire if placed too close to the heating element. Many livestock operations are extreme risk of fire due to the high flammability of bedding, feed, dust, and animals themselves. Fire can spread through a livestock housing in a matter of minutes. Worse yet, fires quickly spread from one livestock house to others, resulting in extreme losses.

Some livestock heating systems may utilize heating mats to generate heat. However, heating mats also distribute heat unevenly. Heat mats are typically constructed of a plastic material into which is embedded a resistive element, such as a wire. When a current is applied across the wire, heat emanates from the wire, creating hotter areas on the heat mat near the embedded wire and cooler areas on the heat mat further away from the embedded wire. Another drawback associated with heat mats is their tendency to overheat and burn the piglets if the heat mats are not attached to a thermostat. Even if a heat mat is attached to a thermostat, due to its uneven heating, the heat mat may still burn the piglets if the thermostat is positioned on a cooler portion of the heat mat. Alternatively, the heat mat may insufficiently heat the piglets if the thermostat is positioned on a warmer area of the heat mat near an embedded wire.

Although heating mats generally operate at lower temperatures than heat lamps, heating mats are still susceptible to catching fire if damaged. For example, when heating mats are used in livestock operations, livestock may apply very large amounts of downward pressure when standing and/or laying on such heating mats. In such applications, heating elements in conventional heating mats may become damaged over time when such weight is repeatedly applied to the heating mats. Damage to heating elements may cause shorts resulting in fires or hot spots that can harm livestock.

Therefore, for all the reasons stated above, and the reasons stated below, there is a need in the art for a livestock heating system that improves upon the state of the art. Thus, it is a primary object of the disclosure to provide a heating system that improves upon the state of the art.

Another object of the disclosure is to provide a heating system that is safe to use.

Yet another object of the disclosure is to provide a heating mat system that is less susceptible to damage.

Another object of the disclosure is to provide a heating system that provides more uniform heat distribution.

Yet another object of the disclosure is to provide a heating system that is configured for use in livestock operations.

Another object of the disclosure is to provide a heating system that is easy to deploy.

Yet another object of the disclosure is to provide a heating system that is easy to install.

Another object of the disclosure is to provide a heating mat system that has a long useful life.

Yet another object of the disclosure is to provide a heating system that is durable.

Another object of the disclosure is to provide a heating system that has a robust design.

Yet another object of the disclosure is to provide a heating system that is self-healing.

Another object of the disclosure is to provide a heating system that is easy to use.

Yet another object of the disclosure is to provide a heating system that is high quality.

These and other objects, features, or advantages of the disclosure will become apparent from the specification, figures and claims.

### SUMMARY OF THE DISCLOSURE

In one or more arrangements, a heating system is provided having one or more heating panels positioned in a housing. The housing has a hollow interior with an open lower end. A first panel is positioned in the open lower end of the housing. The first heating panel includes a heating layer. The heating layer includes a conductive microfilm. A first electrical contact is connected to the conductive microfilm. A second electrical contact is connected to the conductive microfilm. Application of a voltage difference between the first electrical contact and the second electrical contact causes current to flow through the conductive microfilm, thereby generating heat. In one or more arrangements, current flow through the conductive microfilm causes the conductive microfilm to emit infrared radiation.

In one or more arrangements, the conductive microfilm includes a layer of graphene. In one or more arrangements, the conductive microfilm includes a plurality of layers of graphene. In one or more arrangements, the conductive microfilm includes a stack of eight layers of graphene. In one or more arrangements, the conductive microfilm includes a layer of nano-carbon fiber material. In one or more arrangements, the conductive microfilm includes a carbon silver nanomaterial mixture. In one or more arrangements, the conductive microfilm has a non-continuous pattern. In one or more arrangements, the conductive microfilm has a honey-comb pattern. In one or more arrangements, the conductive microfilm is self-healing.

In one or more arrangements, the heating layer includes an upper substrate layer and a lower substrate layer where the conductive microfilm is positioned between the upper substrate layer and the lower substrate layer. In one or more arrangements, the upper substrate layer and the lower substrate layer are a plastic film.

In one or more arrangements, the first heating panel includes a radiant barrier positioned above the heating layer. In one or more arrangements, the first heating panel includes an insulating member positioned above the radiant barrier.

In one or more arrangements, the system includes a second heating panel positioned in the open lower end of the housing. In one or more arrangements, the housing is configured to attach on top of a wall between a pair of livestock stalls. In one or more arrangements, the housing is configured to attach to the wall at a plurality of different heights. In one or more arrangements, the first heating panel is positioned to heat a first one of the pair of livestock stalls and the second heating panel is positioned to heat a second one of the pair of livestock stalls. In one or more arrangements, the first heating panel and the second heating panel adjustable to generate different amounts of heat.

In one or more arrangements, the housing is configured to hold the first heating panel in a recessed position. In one or more arrangements, the housing includes a protective cover positioned under the first heating panel.

### BRIEF DESCRIPTION OF THE DRAWINGS

FIG. 1 is an elevation view of a heating system in accordance with one or more arrangements of the present disclosure; the view showing the system in use and positioned atop a wall of a livestock stall propelling heat downward; wherein the position of the heating system facilitates proper heating of a sow area and a piglet area.

FIG. 2 is a top elevation view of the heating system of FIG. 1, in accordance with one or more arrangements of the present disclosure; the view showing the heating system having a housing wherein the housing has an upper flange located on the top of housing, a front flange located on the front wall and a rear flange located on the rear wall.

FIG. 3 is a bottom elevation view of the heating system of FIG. 1, in accordance with one or more arrangements of the present disclosure; the view showing the heating system having a housing with two halves wherein a left heating panel and a right heating panel are located within the halves and separated by a channel; the view showing the heating system having a front flange on a front wall and a rear flange located on the rear wall.

FIG. 4 is a front elevation view of the heating system of FIG. 1, in accordance with one or more arrangements of the present disclosure; the view showing the heating system having a housing with two halves wherein the two halves are separated by a channel; the view showing the heating system having an upper flange located on the top of the housing and a front flange located on the front wall of the housing wherein the front flange is adjustable by a fastener.

FIG. 5 is a rear elevation view of the heating system of FIG. 1, in accordance with one or more arrangements of the present disclosure; the heating system having a housing with two halves wherein the two halves are separated by a channel; the view showing the heating system having an upper flange located on the top of the housing and a rear flange located on the rear wall of the housing wherein the rear flange is adjustable by a fastener.

FIG. 6 is a side elevation view of the heating system of FIG. 1, in accordance with one or more arrangements of the present disclosure; the view showing the heating system having a housing wherein the housing has an upper flange located on the top of housing, a front flange located on the front wall, and a rear flange located on the rear wall; the view showing the upper flange having an opening which creates a handle.

FIG. 7 is a top perspective view of the heating system of FIG. 1, the heating system having a housing with two halves separated by a channel, in accordance with one or more arrangements of the present disclosure; the view showing the housing having an upper flange located on the top of housing and a front flange located on the front wall. The upper flange having an opening which creates a handle.

FIG. 8 is a bottom perspective view of the heating system of FIG. 1, in accordance with one or more arrangements of the present disclosure; the view showing the heating system having a housing with two halves wherein a left heating panel and a right heating panel are located and separated by a channel; the view showing the housing having a front flange located on the front wall and a rear flange located on the rear wall; the view showing the upper flange having an opening which creates a handle.

FIG. 9 is a cut away view of the heating system of FIG. 1, in accordance with one or more arrangements of the present disclosure; the view showing the heating system having a housing with two halves wherein heating panels are located and separated by a channel; the heating panels having a heating layer, a radiant barrier, and an insulating member.

FIG. 10 is an exploded view of the heating system of FIG. 1, in accordance with one or more arrangements of the present disclosure; the view showing the heating system having a housing with two halves wherein heating panels are located and separated by a channel; the view showing the heating panels having a heating layer, a radiant barrier, and an insulating member; the view showing the housing also having an upper flange located on the top of housing and a front flange located on the front wall of the housing.

FIG. 11 is a front elevation view of one half of the housing of the heating system of FIG. 1, in accordance with one or more arrangements of the present disclosure; the view showing one half of the housing having an upper flange located on the top of the housing and a cut out which makes up one half of the channel of the housing when connected with a second half of the housing.

FIG. 12 is a front elevation view of the heating system of FIG. 1, in accordance with one or more arrangements of the present disclosure; the view showing the heating system installed proximate the top of the wall; the view showing the wall located within the channel of the housing and secured in place by fasteners.

FIG. 13 is a front elevation view of the heating system of FIG. 1m in accordance with one or more arrangements of the present disclosure; the view showing the heating system installed at a lower position along a wall; the view showing the wall located within the channel of the housing and secured in place by fasteners.

FIG. 14 is a cut away view of a heating layer of a heating panel of a heating system, in accordance with one or more arrangements of the present disclosure; the view showing the heating layer having an upper substrate layer, a conductive microfilm, and a lower substrate layer; the view showing electrical contacts located on the upper substrate layer.

FIG. 15 is a cut away view of a heating layer of a heating panel of a heating system, in accordance with one or more arrangements of the present disclosure; the view showing the heating layer having an upper substrate layer, a conductive microfilm, and a lower substrate layer, wherein electrical contacts are located on the upper substrate layer.

FIG. 16 is a schematic of the control system for a heating system, in accordance with one or more arrangements of the present disclosure; the view showing the control system having a user interface and sensors which send information to the control circuit.

FIG. 17 is a top elevation view of a heating system, in accordance with one or more arrangements of the present disclosure; the view showing the heating system having a housing wherein the housing has a handle, fasteners, and a cable gland located on the top of the housing.

FIG. 18 is a bottom elevation view of the heating system, in accordance with one or more arrangements of the present disclosure; the view showing the heating system having a housing wherein the housing has an open bottom and a cable gland located on the inside of the housing.

FIG. 19 is a bottom view of a housing of the heating system, in accordance with one or more arrangements of the present disclosure; the view showing walls of the housing of the heating system flayed out to show the front wall, back wall, right side, and left side of the housing.

FIG. 20 is a top elevation view of a base plate for use in a heating system, in accordance with one or more arrangements of the present disclosure.

FIG. 21 is a side elevation view of a heating system of FIG. 1, in accordance with one or more arrangements of the present disclosure; the view showing the heating system having a housing wherein the housing has a handle and fasteners.

FIG. 22 is a top perspective view of a heating system, in accordance with one or more arrangements of the present disclosure; the view showing the heating system having a pair of housing and a bracket assembly; the view showing the pair of housing having handles, fasteners, and a cable gland; the view showing the bracket assembly having a plurality of clips.

FIG. 23 is an alternative side elevation view of a heating system, in accordance with one or more arrangements of the present disclosure; the view showing the heating system having a pair of housing and a bracket assembly; the view showing the bracket assembly having a base and a pair of legs, wherein the pair of legs are inserted within connecting members and secured by a plurality of clips.

FIG. 24 is a top perspective view of a heating system, in accordance with one or more arrangements of the present disclosure; the view showing the heating system having a housing wherein the housing has a handle, fasteners, and a cable gland; the view showing the fasteners of the housing a located on top of the housing and configured to allow suspension.

FIG. 25 is an exploded view of a heating system, in accordance with one or more arrangements of the present disclosure; the view showing the heating system having a housing and a heating panel; the view showing the heating panel comprising a base plate, a heating layer, a frame, a radiant barrier, an insulating later, and a gasket.

FIG. 26 is an exploded view of a heating system, in accordance with one or more arrangements of the present disclosure; the view showing the heating system having a housing, wherein the housing has a handle, fasteners, and a cable gland; the view showing a base plate, a heating layer and an insulating layer are located within the housing; the view showing radiant barrier omitted.

FIG. 27 is a view of a heating system, in accordance with one or more arrangements of the present disclosure; the view showing the heating system in use on the wall of a livestock stall.

FIG. 28 is an upper perspective view of the heating system of FIG. 1 in use on the wall of a livestock stall, in accordance with one or more arrangements of the present disclosure.

FIG. 29 is a close up partial view of a heating layer of a heating system, in accordance with one or more arrangements of the present disclosure; the view showing the heating layer located above the base plate and below an insulating layer and connected to electrical wiring.

FIG. 30 is a side elevation view of a heating system, in accordance with one or more arrangements of the present disclosure; the view showing the heating system having a housing which houses an insulating layer and electrical wiring; the view showing the electrical wiring is delivered through a cable gland located on the top of the housing. The housing also having a handle and fasteners; the view showing heating panel exploded (with insulating layer separated from heading layer) to provide a view of the wiring.

FIG. 31 is a top cut away view of the heating system of FIG. 30, in accordance with one or more arrangements of the present disclosure, the view showing the heating system having electrical wiring, a thermostat, a ground wire, a neutral wire, a top component of a cable gland and a bottom component of a cable gland.

FIG. 32 is a cut away view of a heating system, in accordance with one or more arrangements of the present disclosure; the view showing the heating system having a housing which houses an insulating layer, a heating layer, a base plate and electrical wiring. The electrical wiring is delivered through a cable gland located on the top of the housing.

FIG. 33 is a cut away view of a heating system, in accordance with one or more arrangements of the present disclosure; the view showing the heating system having a housing which houses an insulating layer, a heating layer, a base plate and electrical wiring; the view showing the electrical wiring is delivered through a cable gland located on the top of the housing.

FIG. 34 is a top elevation view of a heating system, in accordance with one or more arrangements of the present disclosure; the view showing the heating system having a bracket assembly; the view showing the bracket assembly having a base connected to support beams through fasteners; the view showing the support beams configured to connect to the pair of housing through hooks that connect to the fasteners of the pair of housing.

FIG. 35 is a bottom elevation view of the heating system of FIG. 34, in accordance with one or more arrangements of the present disclosure; the view showing the heating system having a bracket assembly.

FIG. 36 is a front elevation view of the heating system of FIG. 34, in accordance with one or more arrangements of the present disclosure; the view showing the heating system having a bracket assembly; the view showing the bracket assembly having a base with a pair of legs that are secured to a wall by a fastener; the view showing the base of the bracket assembly is configured to connect to support beams through fasteners; the view showing the support beams are configured to connect to the pair of housing through hooks that loop through the fasteners of the housing.

FIG. 37 is a back elevation view of the heating system of FIG. 34, in accordance with one or more arrangements of the present disclosure; the view showing the heating system having a bracket assembly; the view showing the bracket assembly having a base with a pair of legs that are secured to a wall by a fastener; the view showing the base of the bracket assembly configured to connect to support beams through fasteners; the view showing the support beams configured to connect to the pair of housing through hooks that loop through the fasteners of the housing.

FIG. 38 is a side elevation view of the heating system of FIG. 34, in accordance with one or more arrangements of the present disclosure; the view showing the heating system having a bracket assembly; the view showing the bracket assembly having a base with a pair of legs; the view showing the base of the bracket assembly configured to connect to support beams through fasteners; the view showing the support beams configured to connect to the pair of housing through hooks that loop through the fasteners of the housing.

FIG. 39 is a side elevation view of one half of the heating system of FIG. 34, in accordance with one or more arrangements of the present disclosure; the view showing the heating system having a bracket assembly; the view showing the bracket assembly having a base with a pair of legs; the view showing the base of the bracket assembly configured to connect to support beams through fasteners; the view showing the support beams configured to connect to the pair of housing through hooks that loop through the fasteners of the housing.

FIG. 40 is a top perspective view of the heating system of FIG. 34, in accordance with one or more arrangements of the present disclosure; the view showing the heating system having a bracket assembly; the view showing the bracket assembly having a base with a pair of legs; FIG. 34, in accordance with one or more arrangements of the present disclosure; the view showing the base of the bracket assembly configured to connect to support beams through fasteners; the view showing the support beams are configured to connect to the pair of housing through hooks that loop through the fasteners of the housing.

FIG. 41 is a top perspective view of the heating system of FIG. 34, in accordance with one or more arrangements of the present disclosure; the view showing the heating system having a bracket assembly; the view showing the bracket assembly having a base with a pair of legs; the view showing the base of the bracket assembly configured to connect to support beams through fasteners; the view showing the support beams configured to connect to the pair of housing through hooks that loop through the fasteners of the housing.

FIG. 42 is an exploded view of the heating system of FIG. 34, in accordance with one or more arrangements of the present disclosure; the view showing the heating system having a bracket assembly; the view showing the bracket assembly having a base with a pair of legs; the view showing the base of the bracket assembly configured to connect to support beams through fasteners; the view showing the support beams are configured to connect to the pair of housing through hooks that loop through the fasteners of the housing.

FIG. 43 is a side cut away view of the heating system of FIG. 34, in accordance with one or more arrangements of the present disclosure; the view showing the heating system having a bracket assembly; the view showing the bracket assembly comprises a base with a pair of legs; the view showing the bracket assembly configured to connect to support beams through fasteners; the view showing support beams configured to connect to the pair of housing through hooks that loop through the fasteners of the housing.

### DETAILED DESCRIPTION

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in and/or described with reference to certain figures and/or embodiments, it will be appreciated that features from one figure and/or embodiment may be combined with features of another figure and/or embodiment even though the combination is not explicitly shown and/or explicitly described as a combination. In the depicted embodiments, like reference numbers refer to like elements throughout the various drawings.

It should be understood that any advantages and/or improvements discussed herein may not be provided by various disclosed embodiments, and/or implementations thereof. The contemplated embodiments are not so limited and should not be interpreted as being restricted to embodiments that provide such advantages and/or improvements. Similarly, it should be understood that various embodiments may not address all or any objects of the disclosure and/or objects of the invention that may be described herein. The contemplated embodiments are not so limited and should not be interpreted as being restricted to embodiments that address such objects of the disclosure and/or invention. Furthermore, although some disclosed embodiments may be described relative to specific materials, embodiments are not limited to the specific materials and/or apparatuses but only to their specific characteristics and capabilities and other materials and apparatuses can be substituted as is well understood by those skilled in the art in view of the present disclosure. Moreover, although some disclosed embodiments may be described in the context of farming, the embodiments are not so limited. It is appreciated that the embodiments may be adapted for use in other applications which may be improved by the disclosed structures, arrangements and/or methods.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation and/or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange and routing between two electronic devices, including intermediary devices, networks, etc., connected wirelessly or not.

It will be understood that, although the ordinal terms “first,” “second,” etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments and/or methods.

Similarly, the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually, and/or sequentially, to provide looping and/or other series of operations aside from single operations described below. It should be presumed that any embodiment and/or method having features and functionality described below, in any workable combination, falls within the scope of example embodiments.

As used herein, various disclosed embodiments may be primarily described in the context of a heating system for livestock. However, the embodiments are not so limited. It is appreciated that the embodiments may be adapted for use in various other applications, which may be improved by the disclosed structures, arrangements and/or methods. The system is merely shown and described as being used in the context of a heating system for livestock for ease of description and as one of countless examples.

### System 10:

In various embodiments, a heating system 10 (or simply system 10) may be formed of any suitable size, shape, and design and is configured to generate and direct heat downward when operated to facilitate, for example, care of livestock. In the arrangement shown, as one example, system 10 includes a pair of heating panels 12, positioned in housing 20, among other components.

### Heating Panel(s) 12:

Heating Panels 12 are formed of any suitable size, shape, and design and are configured to generate radiant heat and facilitate connection with housing 20. In the arrangement shown, as one example, heating panels 12 each include a heating layer 14, a radiant barrier 16, and an insulating member 18 (also referred to as an insulating layer), among other components.

### Heating Layer 14:

Heating layer 14 is formed of any suitable size, shape, and design and is configured to generate radiant heat. In the arrangement shown, as one example, heating layer 14 includes a conductive microfilm 28, one or more substrate layers 30, and a set of electrical contacts 34/36 electrically connected to the conductive microfilm 28. During operation, electric potential difference is applied between the electrical contacts 34/36, which causes current to flow across the conductive microfilm 28, which in turn generates heat.

### Conductive Microfilm 28:

Conductive microfilm 28 is formed of any suitable size, shape, and design and is configured to provide a conductive pathway that extends along heating layer 14 between electrical contacts 34/36 and that generates heat in response to electric current moving along the conductive pathway. In the arrangement shown, as one example, conductive microfilm 28 has a generally planar rectangular shape having an upper surface 38 and lower surface 40 extending between a front edge 42, a rear edge 44, and opposing side edges 46.

In one or more arrangements, conductive microfilm 28 is formed by one or more layers of graphene. Graphene generates thermal and infrared heat when current is applied to it. However, graphene has not been a material of choice for larger applications due to the cost and complexity of graphene manufacture. For example, it can be difficult to form graphene at larger scales without defects. However, through careful observation and experimentation, it has been surprisingly discovered that graphene layers operate very well as a heating element even when defects are created in manufacture and/or use due to the high thermal conductivity of graphene. For example, if defects (e.g., cracks) appear in a graphene layer during manufacture or use, conductive microfilm 28 is able to route current around the defects to continue operation of system 10. In this manner, the conductive microfilm 28 is self-healing. While routing of current around defects may cause more electric current to flow through certain portions of conductive microfilm 28, the high thermal conductivity of graphene is able to distribute heat away from those portions to portions where less electric current has flowed to provide relatively even heat distribution. The graphene and some other nano-carbon fiber materials are also self-healing at a molecular level. For example, experimentation has shown that graphene has a tendency of reconnecting bonds between carbon atoms that are separated by small distances (e.g., 0.3-0.5 nm).

In the arrangement shown, as one example, conductive microfilm 28 is formed by a laminate of a plurality of graphene layers. The use of multiple layers of graphene in conductive microfilm 28 increases the cumulative temperature generated by the conductive microfilm 28 during operation. In this example arrangement conductive microfilm 28 is a laminate of eight (8) graphene layers. The combined graphene layers reach approximately 260 degrees Fahrenheit during operation, with each added layer of graphene providing approximately a 30 degree Fahrenheit increase in temperature.

However, the embodiments are not so limited. Rather, it is contemplated that in some various arrangements, conductive microfilm 28 may include any number of graphene layers or may only include a single graphene layer.

Although some arrangements may be primarily described with reference to conductive microfilm 28 formed of graphene, the embodiments are not so limited. Rather, it is contemplated that in some various arrangements, conductive microfilm 28 may be formed of various conductive materials including but not limited to: graphene, nano-carbon fiber materials, metallic materials such as copper, silver, gold, aluminum, tungsten, and/or other metallic materials, and/or a combination of various materials such as a carbon silver nanomaterial mixture.

In one or more arrangements, microfilm 28 is distributed along heating layer 14 in a non-continuous pattern. In the arrangement shown, as one example, microfilm 28 has graphene extending along a honeycomb pattern. However, the embodiments are not so limited. Rather it is contemplated that in some various different arrangements, conductive microfilm 28 may extend in a continuous manner or non-continuous manner including but not limited to for example, an arrangement of triangles, squares, pentagons, hexagons (e.g., honeycomb shaped), and/or any other discontinuous shape or pattern.

Substrate Layer(s) 30/32:

In one or more arrangements, heating layer 14 includes one or more substrate layer(s) 30/32. Substrate layer(s) 30/32 are formed of any suitable size, shape, and design and are configured to operably connect with and support conductive microfilm 28 and/or electrical contacts 34/36. In the arrangement shown, as one example, heating layer 14 includes an upper substrate layer 30 attached to upper surface 38 of conductive microfilm 28 and a lower substrate layer 32 attached to lower surface 40 of conductive microfilm 28. However, the embodiments are not so limited. For example, in one or more arrangements, heating layer 14 has conductive microfilm 28 supported by a single substrate layer 30. Further, in one or more arrangements, heating layer 14 may include conductive microfilm 28 without any substrate layers 32.

In the arrangement shown, substrate layers 30/32 have similar shape to conductive microfilm 28. In this example arrangement, upper substrate layer 30 has generally planar rectangular shape having an upper surface 50 and a lower surface 52 extending between a front edge 54, rear edge 56, and opposing side edges 58, which are generally aligned with front edge 42, rear edge 44, and opposing side edges 46 of conductive microfilm 28, respectively, in this example. Similarly, in this example arrangement, lower substrate layer 32 has generally planar rectangular shape having an upper surface 60 and a lower surface 62 extending between a front edge 64, rear edge 66, and opposing side edges 68, which are generally aligned with front edge 42, rear edge 44, and opposing side edges 46 of conductive microfilm 28, respectively, in this example.

Substrate layer(s) 30/32 may be formed of various materials configured to support and prevent damage to conductive microfilm 28 during operation. In one or more arrangements, as one example, substrate layer(s) 30/32 are formed of a fiberglass resin backing. However, the embodiments are not so limited. Rather, it is contemplated that in some various arrangements, substrate layer(s) 30/32 may be formed of various materials including but not limited to, for example, polymers, resins, textiles, composites, and/or any other natural or synthetic materials.

In some arrangements, conductive microfilm 28 is formed on one of substrate layers 30/32, for example by depositing graphene or other conductive material on the substrate layer 30/32. In some other arrangements, conductive microfilm 28 may be formed and then transferred and affixed to one or both of substrate layers 30/32. For example, in one or more arrangements, a substrate layer 30/32 may be coated with an adhesive and used to lift conductive microfilm 28 off of a surface on which it was formed.

Electrical Contacts 34/36:

Electrical contacts 34/36 are formed of any suitable size, shape, and design and are configured to facilitate application of an electric potential difference across conductive microfilm 28 and thereby induce flow of current across conductive microfilm 28 and cause conductive microfilm 28 to generate heat. In one arrangement shown, as one example, electrical contacts 34/36 each have a first portion 72 extending along opposing front and rear edges 42/44 of conductive microfilm 28 between opposing side edges 46 and a second portion 74 extending inward along one of side edges 46 to a connection point 76. In this example arrangement, a first electric contact 34 extends along and is electrically connected to front edge 42 of conductive microfilm 28 and a second electric contact 36 extends along and is electrically connected to rear edge 44 of conductive microfilm 28. In this example arrangement, when an electric potential difference is applied to the first and second electric contacts 34/36, the electric potential difference is provided to the front edge 42 and rear edge 44 of conductive microfilm 28, which causes current to flow from a negatively charged one of the first and second electric contacts 34/36, through conductive microfilm 28, to a positively charged one of the first and second electric contacts 34/36.

However, the embodiments are not so limited. Rather, it is contemplated that in some various arrangements, electrical contacts 34/36 may have various different shapes configured to apply voltage potentials to various portions of conductive microfilm 28. For example, in one or more arrangements, electrical contacts 34/36 may have comb shapes positioned with teeth interleaved to increase the surface area at which electrical contacts 34/36 electrically connect with conducive microfilm 28. It is contemplated, that electrical contacts 34/36 may additionally or alternatively have any other shape or configuration suitable for distributing power across conducive microfilm 28.

Alternative Shapes of Heating Layer 14

Although some arrangement may be primarily shown and/or described with reference to heating panels 12 having a heating layer 14 having a relatively flat planar shape, the embodiments are not so limited. Rather, it is contemplated that in one or more arrangements, heating layer 14 may have a concave, convex, multifaceted or any other shape to facilitate different distribution and/or focusing radiant heat that is generated during operation. For example, in one more arrangements heating layer 14 may have a convex shape that directs generated radiant heat outward. Conversely, in one or more arrangements, heating layer 14 may have a concave shape that directs heat inward to a focal point or area.

### Radiant Barrier 16:

Radiant barrier 16 is formed of any suitable size, shape, and design and is configured to reflect radiant heat back toward heating layer 14. In some various different arrangements, insulating member 18 may include various methods and/or means for reflecting radiant heat including but not limited to, for example, metal foils (e.g., aluminum foil), metal sheets and/or plates, metalized thin films (e.g., reflective mylar), heat-reflective fabric (e.g., metalized fabrics), reflective paints, and/or any other radiant reflective materials.

In the arrangement shown, as one example, radiant barrier 16 is positioned above heating layer 14 and has a generally planar rectangular shape having an upper surface 82 and a lower surface 84 extending between a front edge 86, a rear edge 88, and opposing side edges 90. In this example arrangement, front edge 86, rear edge 88, and side edges 90 are generally aligned with edges 42, 44, and 46 of heating layer 14, respectively.

In one or more arrangements, radiant barrier 16 is positioned between heating layer 14 and insulating member 18. However, the arrangements are not so limited. Rather, it is contemplated that in one or more arrangements, radiant barrier 16 may additionally or alternatively be positioned above insulating member 18 or may be omitted entirely with insulating member 18 positioned on heating layer 14.

### Insulating Member 18:

Insulating member 18 is formed of any suitable size, shape, and design and is configured to inhibit the transfer of heat upward away from heating layer 14. In the example arrangement shown, as one example, insulating member 18 is positioned above radiant barrier 16 and has a generally planar rectangular shape having an upper surface 98 and a lower surface 100 extending between a front edge 102, a rear edge 104, and opposing side edges 106. In some various different arrangements, insulating member 18 may include various methods and/or means for insulation including but not limited to, air pockets, fiberglass, foam, cellulose, mineral wool, reflective and/or radiant barriers, and/or any other method and/or means for insulating.

Although some arrangements may be described with reference to radiant barrier 16 and insulating member 18 being implemented as separate components, the embodiments are not so limited. Rather, it is contemplated that in one or more arrangements, radiant barrier 16 may be incorporated as part of insulating member 18 (e.g., as a backing or part of a laminate and/or composite).

### Diffusion Plate 321:

In one or more arrangements, system 10 optionally includes a diffusion plate 321 positioned below heating panel(s) 12. Diffusion plate 321 is formed of any suitably size, shape, and design and is configured to help diffuse heat to provide a more even heat distribution. In one or more arrangements, as one example, diffusion plate may be implemented by a sheet of sheet metal. However, the arrangements are not so limited. Rather, it is contemplated that in some various arrangements, diffusion plate 321 may be implemented using various methods or means including but not limited to various metals, ceramics, composite, or any other materials suitable for diffusing radiant heat.

### Housing 20:

Housing 20 is formed of any suitable size, shape, and design, and is configured to operably connect with and hold one or more heating panel(s) 12 in position for downward directed heating of livestock. In this example arrangement, housing 20 has generally half-cylinder shaped top 120 extending between a front wall 122 and rear wall 124 and curving downward from a center vertex 126 to opposing lower outer side edges 128.

In some various arrangements, housing 20 may be formed of various different materials. In the arrangement shown, housing 20 is formed of thermoplastic polyolefin. However, the embodiments are not so limited. Rather, it is contemplated that in one or more arrangements, housing 20 may be formed of various materials including but not limited to, for example, thermoplastic polyolefin or other plastic, metal, composites, and/or any other suitable material.

### Channel 134:

In this example arrangement, housing 20 includes a downward facing channel 134 extending through and between front wall 122 and rear wall 124. Channel 134 is formed of any suitable size, shape, and design, and is configured to facilitate positing housing 20 over a top edge of a wall 138 between two livestock stalls 140. In the arrangement shown, as one example, channel 134 has a generally rectangular shape and includes a pair of sidewalls 146 each extending between a lower edge 148 and an upper edge 150 from a forward edge 152, where the sidewall connects to front wall 122, to a rearward edge 154, where the sidewall connects to rear wall 124. In this example arrangement, channel 134 has a top wall 158 extending between upper edges 150 of sidewalls 146 from a forward edge 160, where top wall 158 connects to front wall 122, to a rearward edge 162, where top wall 158 connects to rear wall 124.

### Fasteners 166:

In one or more arrangements, housing 20 includes one or more fasteners 166. Fasteners 166 are formed of any suitable size, shape, and design and are configured to facilitate connection of housing 20 to a wall 138 extending into channel 134. In the arrangement shown, as one example, fasteners 166 are thumbscrews. However, the embodiments are not so limited. Rather, it is contemplated that fasteners 166 may utilize various means and methods known in the art including but not limited to, for example, adhesive bonding, chemical bonding, welding, and/or mechanical attachment means such as screws, bolts, threading, interlocks, clips, pins, or other coupling devices.

In the arrangement shown, as one example, fasteners 166 are thumbscrews extending through a pair of front flanges 168 and through a pair of rear flanges 170 that are positioned on opposing sides of channel 134. In this example arrangement, each front flange 168 is formed by a portion of one of the sidewalls 146 that extends forward of front wall 122. Similarly, each rear flange 170 is formed by a portion of one of the sidewalls 146 that extends rearward of rear wall 124. When tightened, the thumbscrew fasteners 166 extend inward to engage and connect with wall 138. In one or more arrangements, fasteners 166 permit housing 20 to connect to wall 138 at different heights to facilitate height adjustment of system 10.

In this example arrangement, top 120, front wall 122, and rear wall 124 of housing 20 form a hollow interior 174 having an open bottom. In this example arrangement, channel 134 partitions the hollow interior 174 into a left partition 176 and a right partition 178. In this example arrangement, a left heating panel 12a is positioned in the open bottom of the left partition 176 of housing 20 and a right heating panel 12b is positioned in the open bottom of the right partition 178 of housing 20. When housing 20 is positioned on top of wall 138, the left heating panel 12a is positioned to heat an area in left one of the livestock stalls 140 and the right heating panel 12b is positioned to heat an area in a right one of the livestock stalls 140. In one or more arrangements, left heating panel 12a and right heating panel 12b may be controlled independent from one another, thereby permitting the livestock stalls 140 to be heated to different temperatures. For example, in one or more arrangements, left heating panel 12a may be operated at a lower temperature suitable for an adult SOW while right heating panel 12b may be operated at a higher temperature suitable for piglets.

### Flanges 182:

In the arrangement shown, housing 20 includes flanges 182 positioned within left partition 176 and right partition 178 to facilitate operable connection of heating panels 12a and 12b to housing 20. In some various different arrangements, heating panels 12 may be connected to flanges 182 or other portion of housing 20 using various means and methods known in the art including but not limited to, for example, adhesive bonding, chemical bonding, welding, and/or mechanical attachment means such as screws, bolts, threading, interlocks, clips, pins, or other coupling devices. In this example arrangement, flanges 182 are positioned above lower outer side edges 128 of top 120, lower edges 148 of sidewalls 146, a lower edge 184 of front wall 122 and a lower edge 186 of rear wall 124, so as to hold heating panels 12 in a recessed position. In this manner heating panels 12 are less susceptible to damages, for example if housing 20 is placed on the ground.

### Protective Covers 188:

In one or more arrangements, housing 20 includes protective covers 188 (not shown) positioned below heating panels 12 to further protect heating panels 12 from impact or livestock bio-contaminants. Protective covers 188 are formed of any suitable size, shape, and design and are configured to provide a physical barrier protecting heating panels 12 while permitting radiant heat to pass to facilitate heating of livestock stalls 140 during operation. In one or more arrangements, protective covers 188 are formed of thermoplastic polyolefin. However, the embodiments are not so limited. Rather, it is contemplated that in one or more arrangements, protective covers 188 may be formed of various materials including but not limited to, for example, thermoplastic polyolefin or other plastic, metal, composites, and/or any other suitable material).

### Halves 196 of Housing 20:

In the arrangement shown, housing 20 is formed by two symmetrical halves 196 that are connected together. However, the embodiments are not so limited. Rather, it is contemplated that in some various different arrangements housing 20 may be formed by any number of individual components or segments that are connected together and/or maybe formed of a single unitary body. In the example arrangement shown, each half generally has a quarter round cylindrical shape formed by a curved top 218 and a side 220 extending between a quarter round front wall 222 and a quarter round rear wall 224.

### Quarter Round Front Wall 222 and Quarter Round Rear Wall 224:

In this example arrangement, quarter round front wall 222 and quarter round rear wall 224 each have a generally planar quarter round shape extending between a bottom edge 228, an inner side edge 230, and curved edge 232 extending from an upper end of side edges to an outer end of bottom edges. In this example arrangement, quarter round front wall 222 and quarter round rear wall 224 each have a rectangular cutaway 236 in a lower inner corner proximate to bottom edge 228 and inner side edge 230 to accommodate channel 134. In this example arrangement, rectangular cutaway 236 has a side edge 238 extending upward from bottom edge 228 to an upper edge 240 extending from an upper end of side edge 238 to inner side edge 230.

### Curved Top 218

In this example arrangement, curved top 218 has a generally rectangular curved planar shape extending between curved edges 232 of quarter round front wall 222 and quarter round rear wall 224 from an upper inner edge 244 to a lower outer edge 246. However, the embodiments are not so limited. Rather, it is contemplated that top 218 may be any shape.

### Side 220:

Side 220 of each half 196 of housing 20 is formed of any suitable size, shape and design and is configured to enclose an inner side of the half 196 and form channel 134 when joined with the side 220 of the other half 196 of housing 20.

In the arrangement shown, as one example, side 220 includes a lower portion 250, a center portion 252, and an upper portion 256. In this example arrangement, lower portion 250 has a generally rectangular shape formed by a sidewall 146 of channel 134. In this example arrangement, center portion 252 has a generally rectangular shape extending inward from upper edge 150 of sidewall 146 to an inner edge 254. In this example arrangement, center portion 252 forms half of top wall 158 of channel 134. In this example arrangement, upper portion 256 extends upward from inner edge 255 of center portion 252 to upper inner edge 244 of curved top 218.

### Upper Flange 260:

In the arrangement shown, as one example, upper portion 256 extends upward beyond upper inner edge 244 of curved top 218 to form an upper flange 260. In this example arrangement, when viewed from the side, upper flange 260 has a generally planar triangular shape extending across housing 20 from quarter round front wall 222 to quarter round rear wall 224. In this example arrangement, upper flange 260 includes an opening 262 in a center portion of upper flange 260, which forms a handle 264 to facilitate lifting of system 10.

### Halves 196 Usable Together or Separately:

In this example arrangement, housing 20 is formed by operably connecting sides 220 of the halves 196 together. In some various different arrangements, sides 220 of the halves 196 together may be connected together using various means and methods known in the art including but not limited to, for example, adhesive bonding, chemical bonding, welding, and/or mechanical attachment means such as screws, bolts, threading, interlocks, clips, pins, or other coupling devices. With halves 196 connected, sides 220 form channel 134, which may facilitate positioning system 10 on and connecting system 10 to wall 138 between two livestock stalls 140. However, the embodiments are not so limited. Rather, it is contemplated that in one or more arrangements, system 10 may be implemented with a single half 196 of housing 20, for example, when heating of only one stall is required and/or to facilitate mounting of system 10 to a side of a wall 138.

### Control System 300:

In one or more arrangements, system 10 may be controlled using various means and/or methods to provide a desired temperature output. In one or more arrangements, system 10 includes a control system 300 configured to adjust the amount of heat generated by heating panels 12 by adjusting voltage and/or current that is applied to electric contacts 34 and 36 of the panels 12. Additionally or alternatively, on one or more arrangements, control system 300 may be configured to connect and disconnect a power source to/from electric contacts 34 and 36. For example, in one or more arrangements, system 10 may include one or more relay switches 298 (not shown) configured to connect and disconnect a power source to/from electric contacts 34 and 36 of one or both the heating panels 12 in response to a control signal from control system 300. As an illustrative example, control system 300 may be configured to adjust temperature output by a heating panel 12 of system 10 by adjusting the amount of time that the power source is connected to electric contacts 34 and 36. For example, control system 300 may connect the power source to electric contacts 34 and 36 for 1 second every 10 seconds when operated at a lower temperature setting and connect the power source to electric contacts 34 and 36 for 1 second every 5 seconds at a higher temperature setting. Additionally or alternatively, on one or more arrangements, control system 300 may be configured to connect and disconnect a power source to/from electric contacts 34 and 36 in response to readings of a temperature sensor to maintain a desired output temperature.

Control system 300 is formed of any suitable any suitable size, shape, and design and is configured to control operation of system 10. In the arrangement shown, as one example, control system 300 includes a control circuit 302, user interface 304, and/or sensors 306, among other components.

### Control Circuit 302:

Control circuit 302 is formed of any suitable size, shape, design and is configured to control operation of various components of system 10 in response to signals of sensors 306 and/or input from user interface 304. In the arrangement shown, as one example, control circuit 302 includes a communication circuit 310, a processing circuit 312, and a memory 314 having software code 316 or instructions that facilitates the operation of system 10.

Processing circuit 312 may be any computing device that receives and processes information and outputs commands according to software code 316 stored in memory 314. For example, in some various arrangements, processing circuit 312 may be discreet logic circuits or programmable logic circuits configured for implementing these operations/activities, as shown in the figures and/or described in the specification. In certain arrangements, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of software code stored in and accessible from memory 314. Memory 314 may be any form of information storage such as flash memory, ram memory, dram memory, a hard drive, or any other form of memory.

Processing circuit 312 and memory 314 may be formed of a single combined unit. Alternatively, processing circuit 312 and memory 314 may be formed of separate but electrically connected components. Alternatively, processing circuit 312 and memory 314 may each be formed of multiple separate but communicatively connected components.

Software code 316 is any form of instructions or rules that direct how processing circuit 312 is to receive, interpret and respond to information to operate as described herein. Software code 316 or instructions are stored in memory 314 and accessible to processing circuit 312. As an illustrative example, in one or more arrangements, software code 316 or instructions may configure processing circuit 312 of control circuit 302 to monitor sensors 306 and perform various preprogramed actions in response to signals from sensors 306 satisfying one or more trigger conditions.

As some illustrative examples, some actions that may be initiated by control circuit 302 in response to signals from sensors 306 and/or user input from user interface 304 include but are not limited to, for example, connecting and disconnecting electric contacts 34 and 36 to/from a power source, controlling voltage and/or current provided by the power source to electric contacts 34 and 36 of heating panel(s) 12, otherwise controlling output temperature provided by system 10, and/or sending notifications to users (e.g., emails, SMS, push notifications, automated phone call, social media messaging, and/or any other type of messaging) regarding operation of system 10 and/or management of livestock.

Communication circuit 310 is formed of any suitable size, shape, design, technology, and in any arrangement and is configured to facilitate communication with devices to be controlled, monitored, and/or alerted by control system 300. In one or more arrangements, as one example, communication circuit 310 includes a transmitter (for one-way communication) or transceiver (for two-way communication). In various arrangements, communication circuit 310 may be configured to communicate with various components of system 10 using various wired and/or wireless communication technologies and protocols over various networks and/or mediums including but not limited to, for example, IsoBUS, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/WIFI, Wi-Max, Bluetooth, Bluetooth low energy, UltraWideband (UWB), 802.15.4/ZigBee, ZWave, GSM/EDGE, UMTS/HSPA+/HSDPA, CDMA, LTE, FM/VHF/UHF networks, and/or any other communication protocol, technology or network.

### Sensors 306:

Sensors 306 are formed of any suitable size, shape, design, technology, and in any arrangement configured to measure factors pertaining to operation of system 10 and/or monitoring and/or management of livestock. In some various arrangements, sensors 306 may include but are not limited to, for example, temperature sensors, voltage sensors, current sensors, location sensors (e.g., GPS sensors), position sensors, switches, motion sensors, speed sensors, proximity sensors, light sensors, cameras, microphones, LIDAR, speed sensors, humidity sensors, moisture sensors, fuel and/or energy sensors, and/or any other type of sensor, and/or various combinations thereof.

In some arrangements, sensors 306 may be formed along with control circuit 302 as a single combined unit. Alternatively, in some arrangements, sensors 306 and control circuit 302 may be communicatively connected by communication circuit 310.

### User Interface 304:

User interface 304 is formed of any suitable size, shape, design, technology, and in any arrangement and is configured to facilitate user control and/or adjustment of various components of system 10. In one or more arrangements, as one example, user interface 304 includes a set of inputs (not shown). Inputs are formed of any suitable size, shape, and design and are configured to facilitate user input of data and/or control commands. In various different arrangements, inputs may include various types of controls including but not limited to, for example, buttons, switches, dials, knobs, a keyboard, a mouse, a touch pad, a touchscreen, a joystick, a roller ball, or any other form of user input. Optionally, in one or more arrangements, user interface 304 includes a display (not shown). Display is formed of any suitable size, shape, design, technology, and in any arrangement and is configured to display information of settings, sensor readings, time elapsed, and/or other information pertaining to operation or system 10 and/or management of livestock. In one or more arrangements, display may include, for example, LED lights, meters, gauges, screen or monitor of a computing device, tablet, and/or smartphone. As an illustrative example, in one or more arrangements system 10 may include one or more LEDs positioned on housing 20 that are configured to light when system 10 is in operation. Such visual indication of when system 10 is in operation may be useful to assist an operator in monitoring and/or reviewing status of system 10 as infrared heat generated by system 10 may not be easily visible. Such visual indicator may help avoid unintended operation of system 10 (e.g., accidentally leaving system 10 on when operation is not intended). In one or more arrangements, display of system 10 may additionally or alternatively be configured to provide a visual indicator indicating a heat and/or temperature setting of system 10.

Additionally, or alternatively, in one or more arrangements, the inputs and/or display may be implemented on a separate device that is communicatively connected to control circuit 302. For example, in one or more arrangements, operation of control circuit 302 may be customized or controlled using a smartphone or other computing device that is communicatively connected to the control circuit 302 (e.g., via Bluetooth, WIFI, and/or the internet).

From the above discussion it will be appreciated that the heating mat system presented herein improves upon the state of the art. More specifically, and without limitation, it will be appreciated that in one or more arrangements, a heating system is presented: that is safe to use; that is less susceptible to damage; that provides more uniform heat distribution; that is configured for use in livestock operations; that is easy to deploy; that is easy to install; that has a long useful life; that is durable; that has a robust design; that is self-healing; that is easy to use; and/or that is high quality. Example embodiments of the invention have been described in an illustrative manner. It is to be understood that the terminology that has been used is intended to be in the nature of words of description rather than of limitation. It will be appreciated by those skilled in the art that other various modifications could be made to the device without parting from the spirit and scope of this disclosure. All such modifications and changes fall within the scope of the claims and are intended to be covered thereby.

### Alternative Arrangement(S):

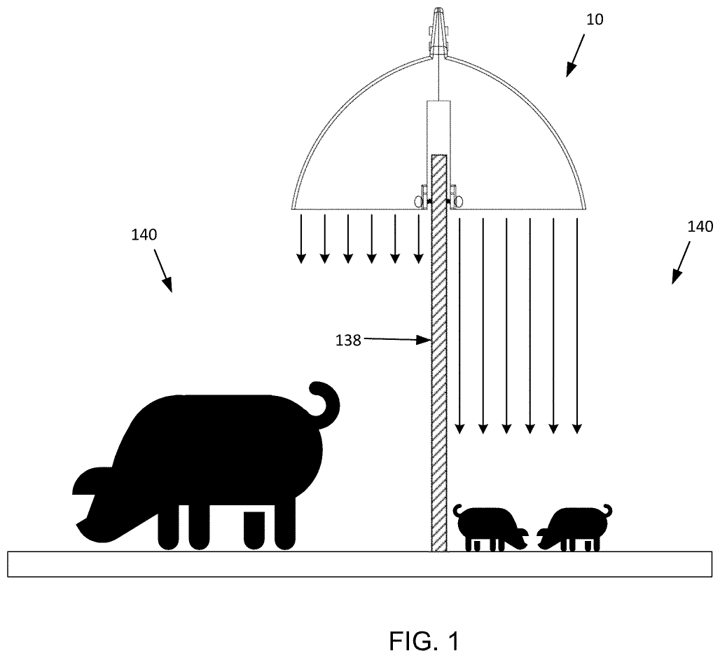

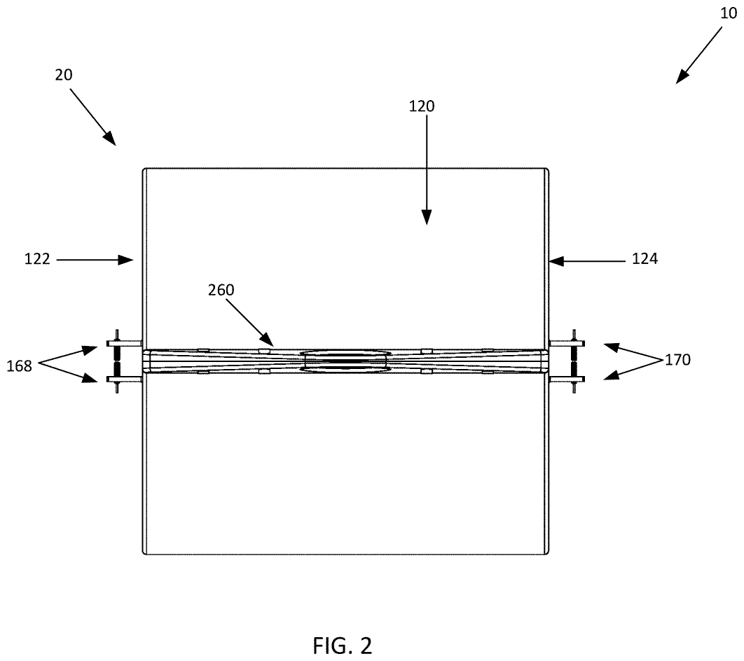

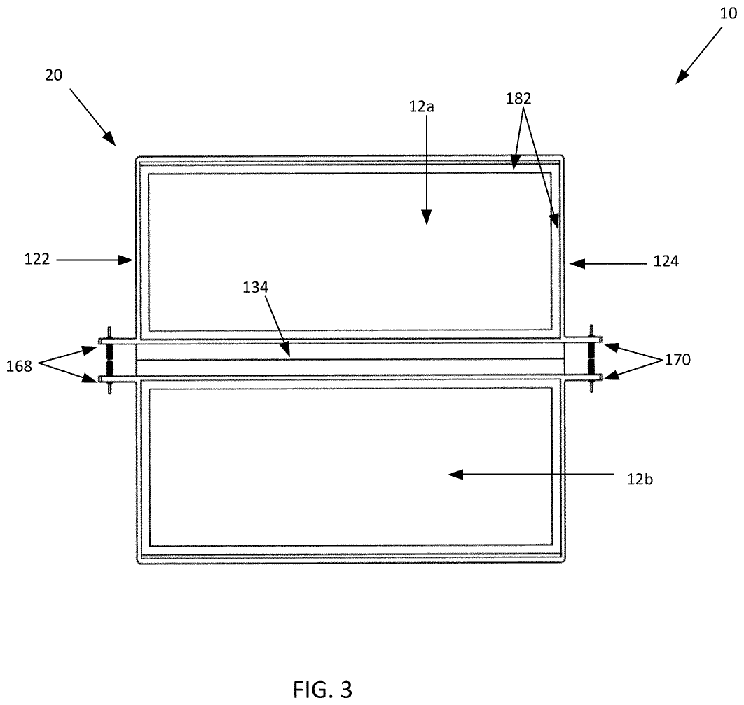

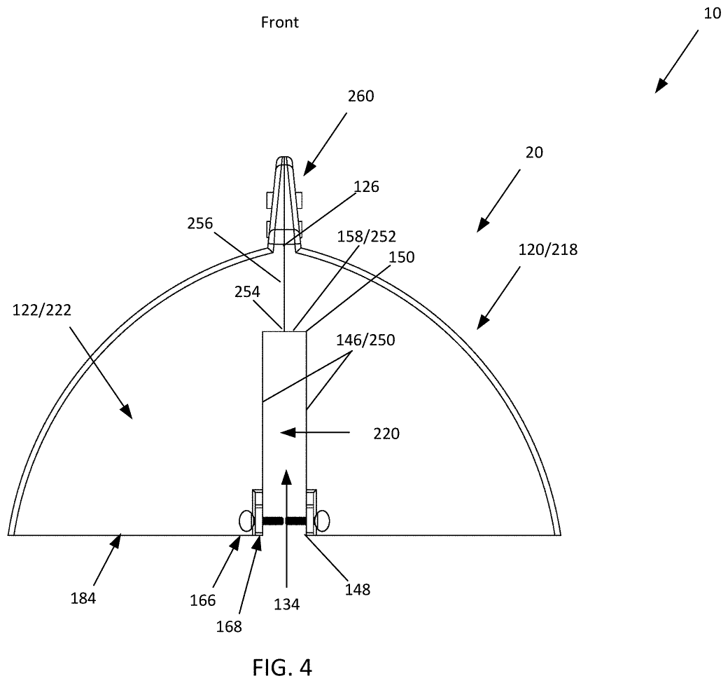

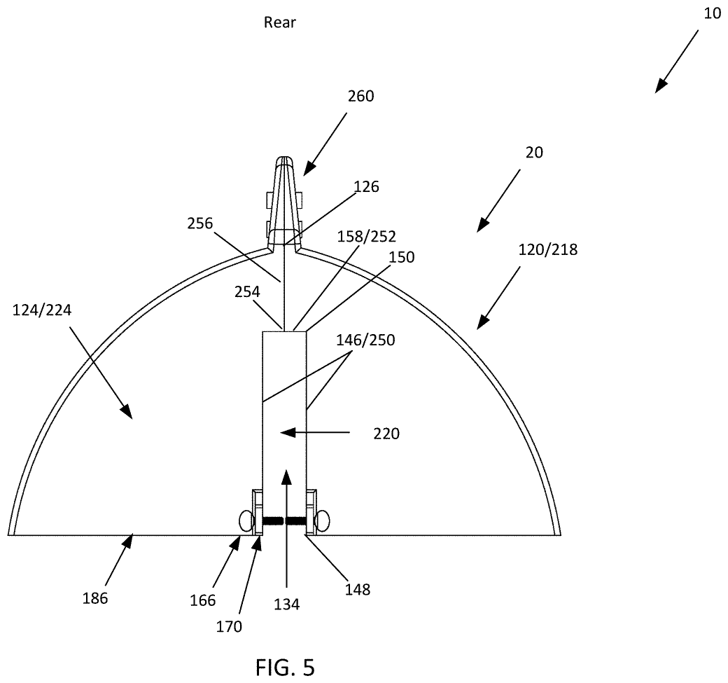

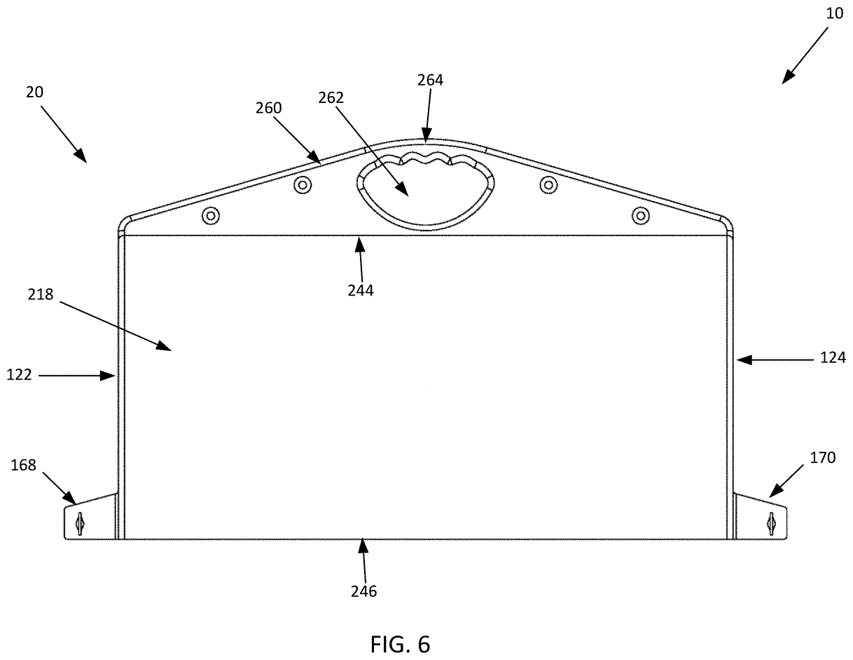

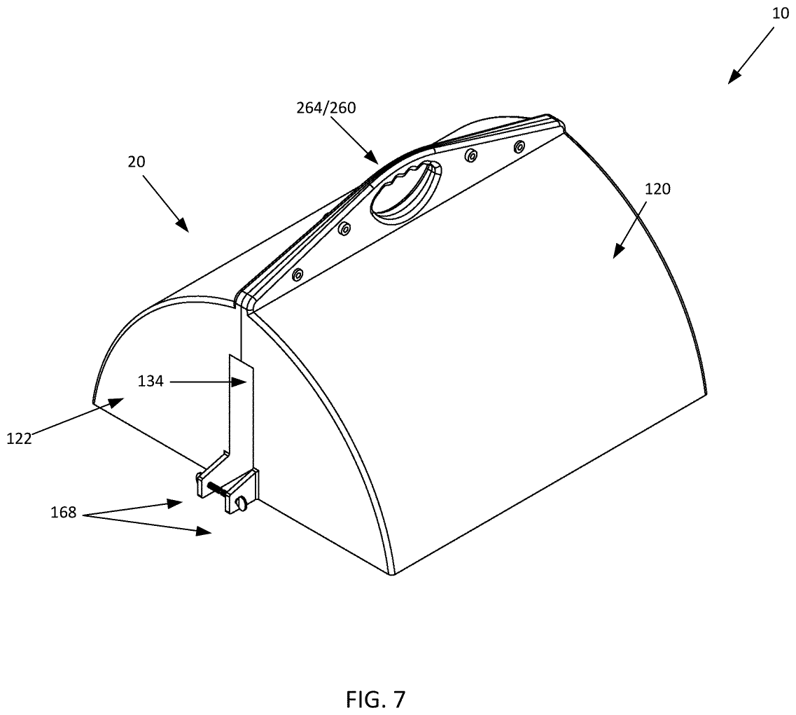

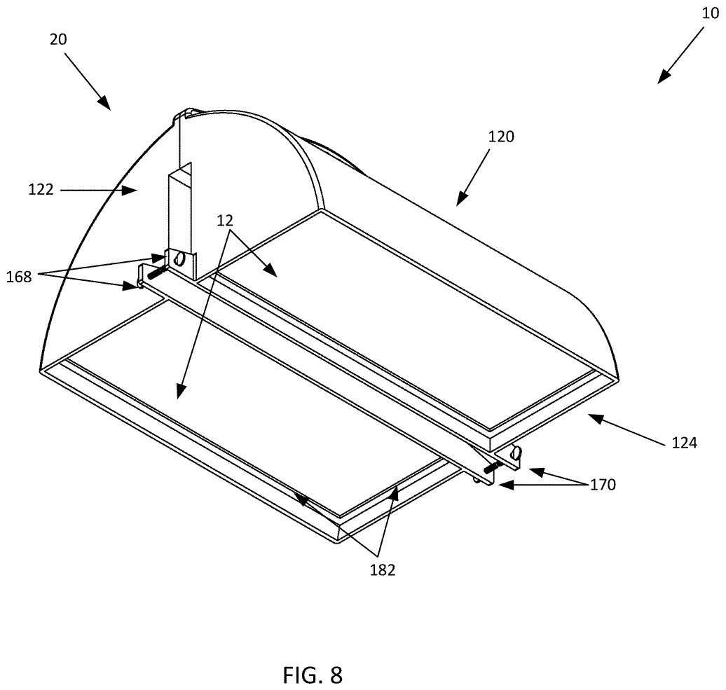

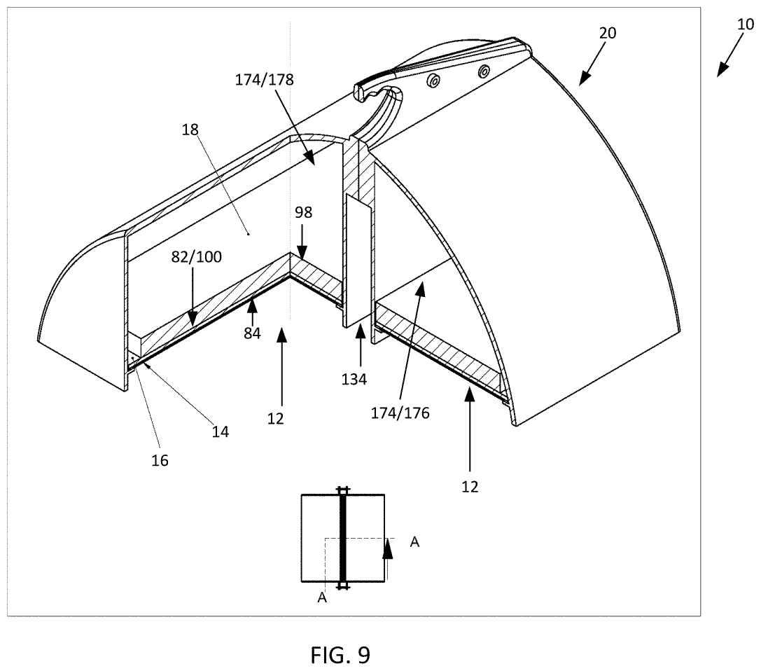

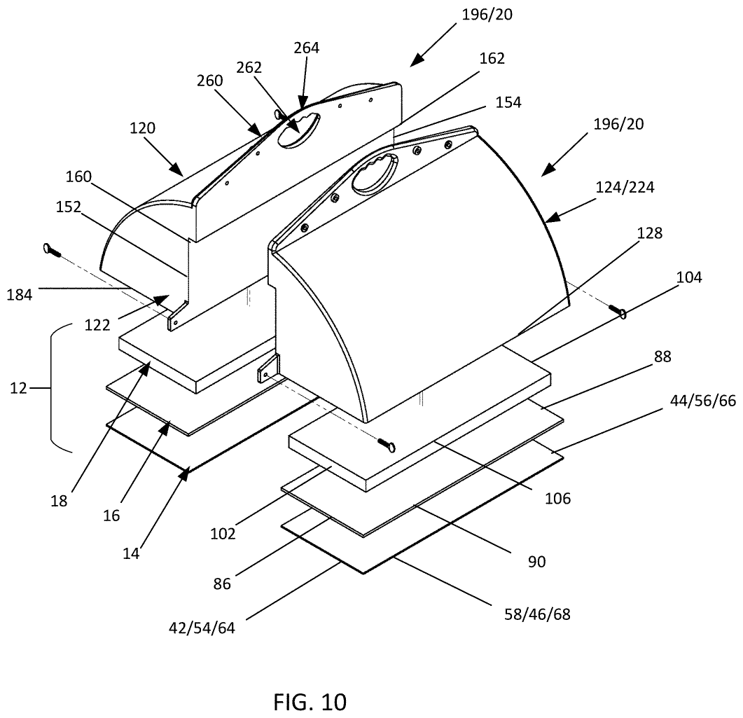

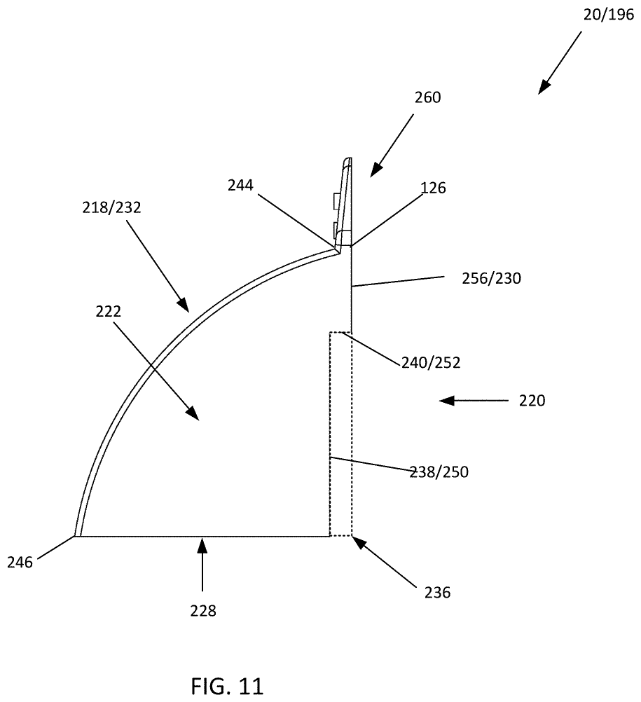

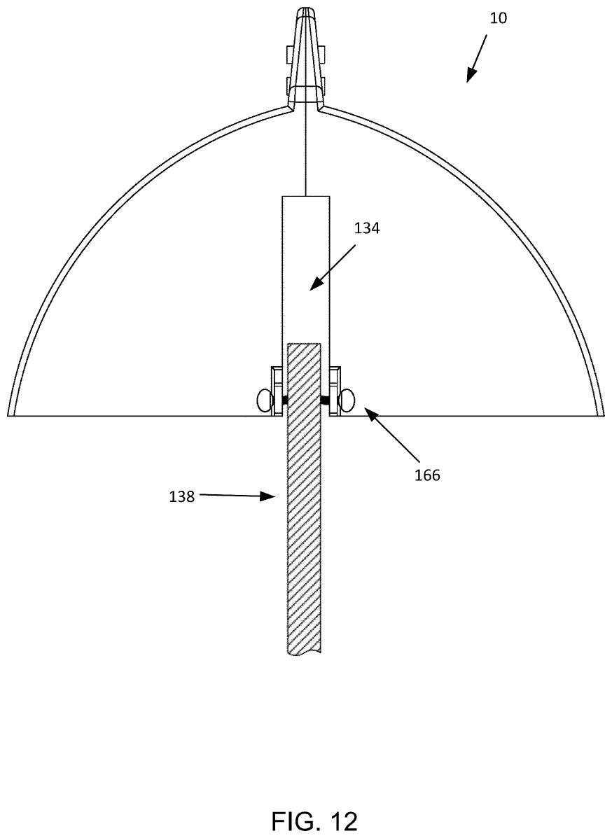

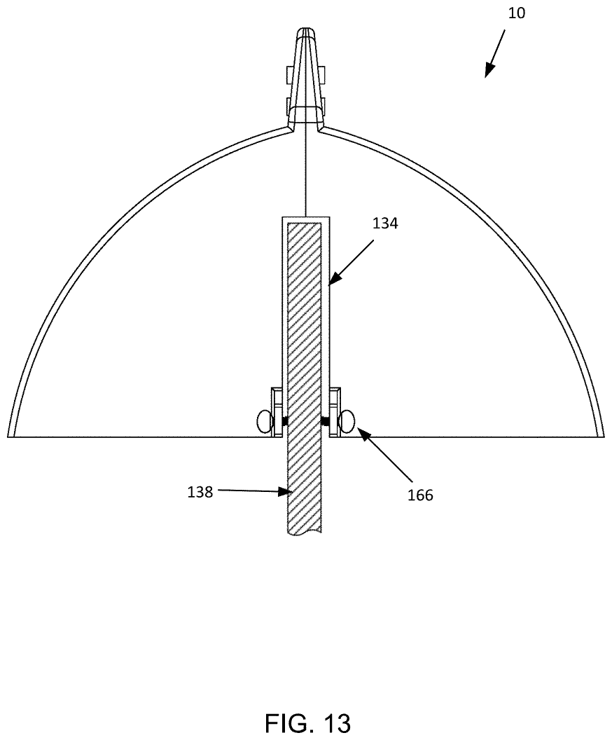

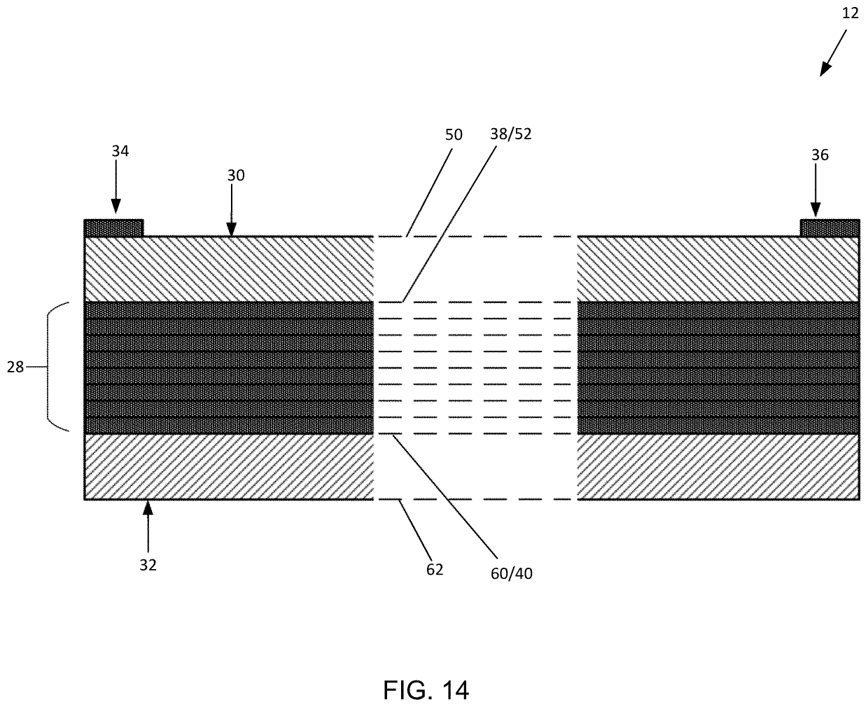

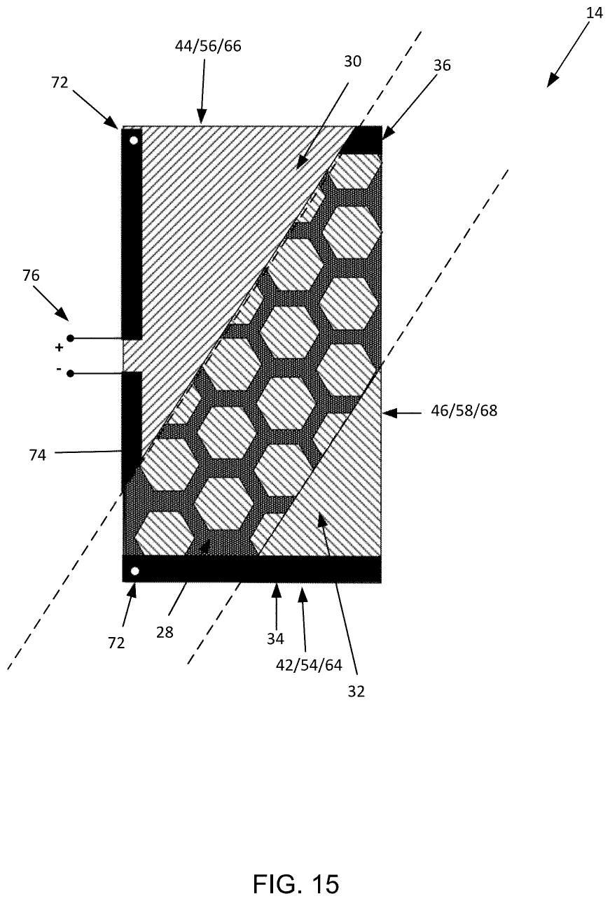

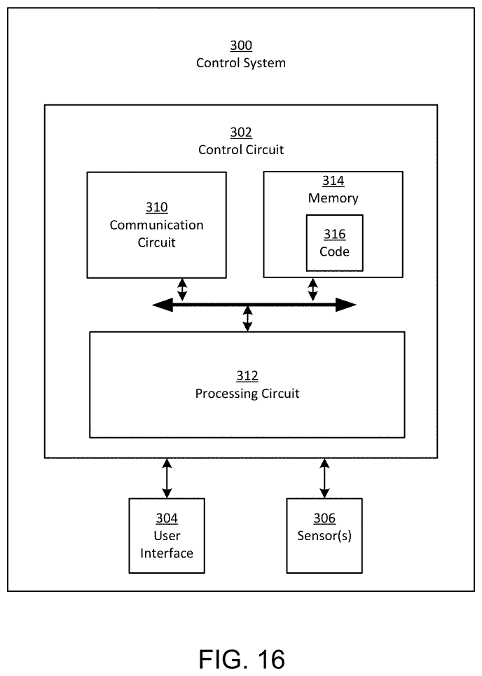

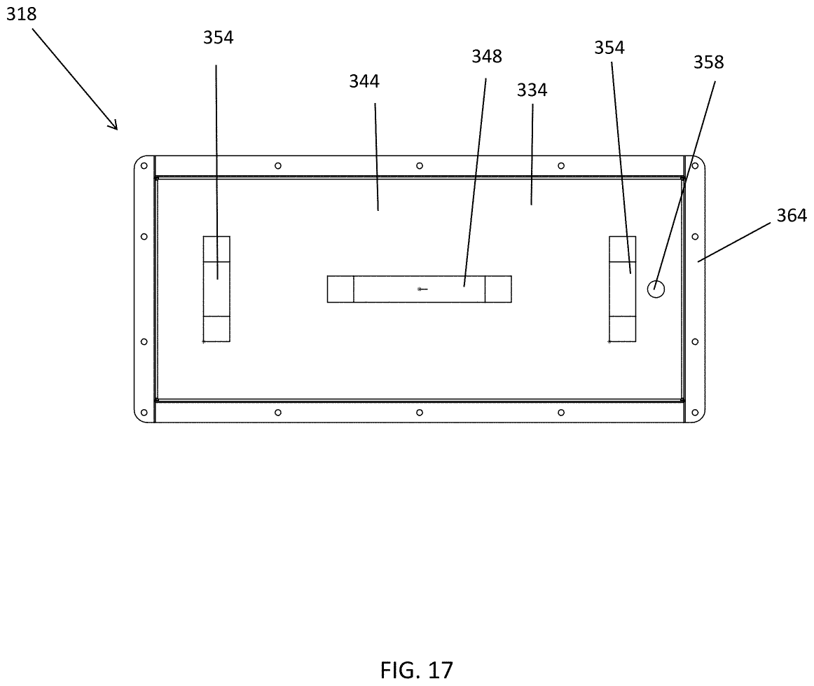

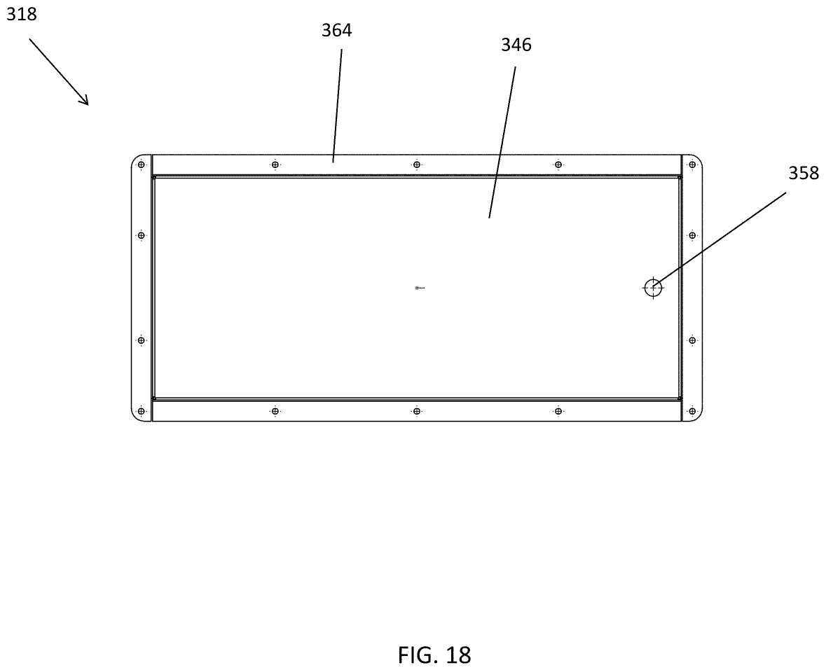

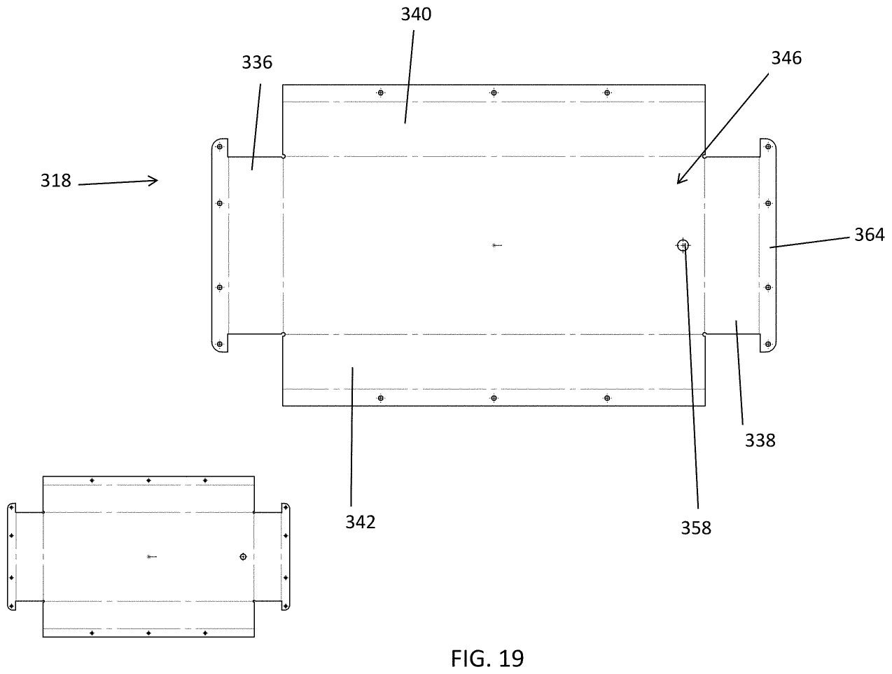

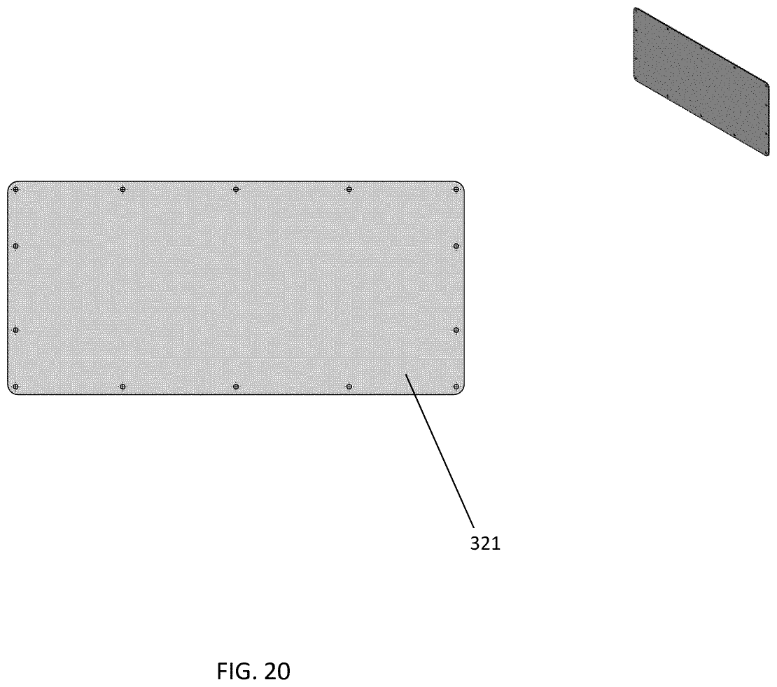

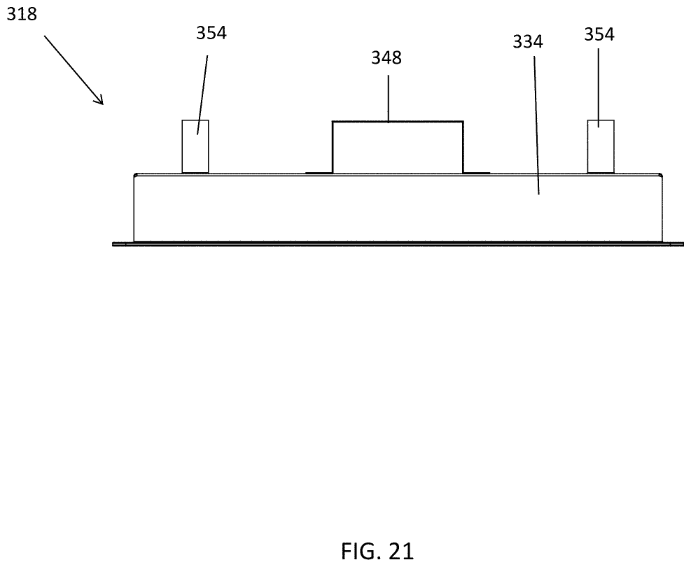

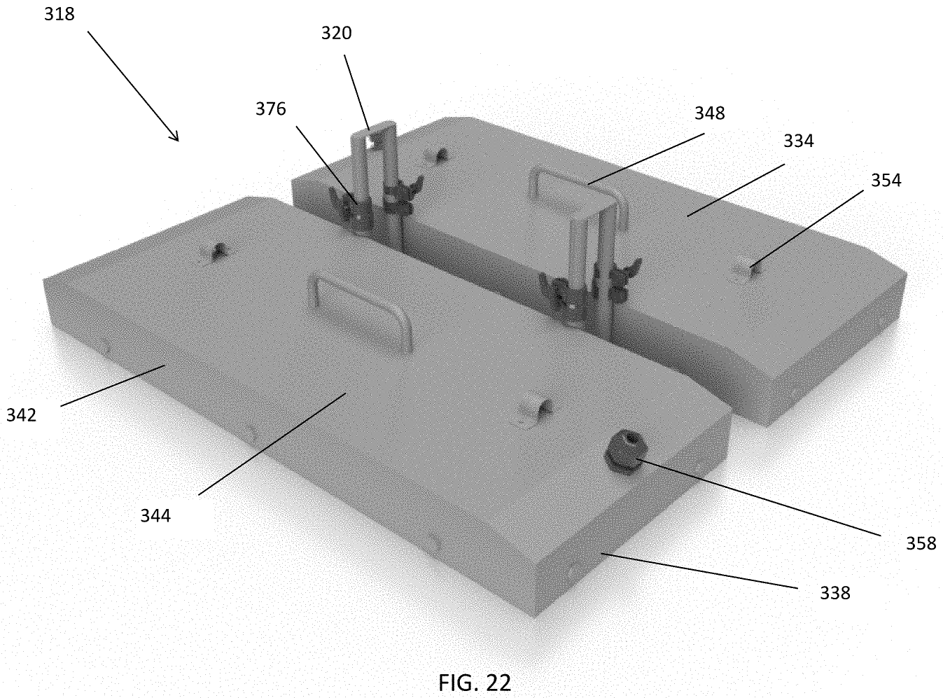

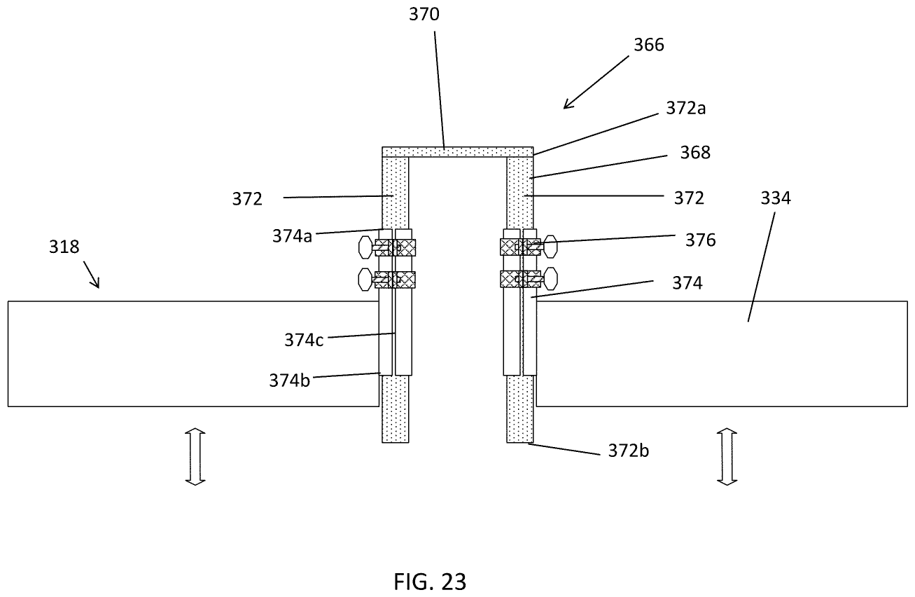

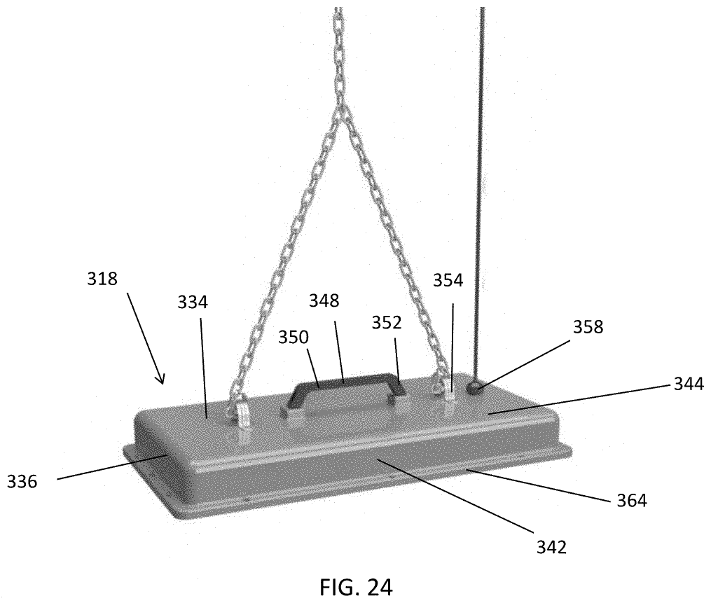

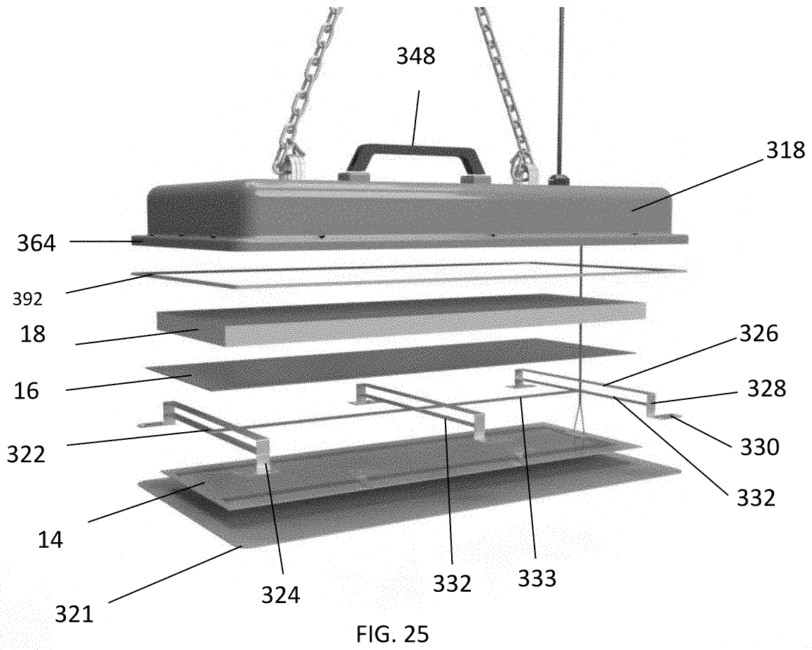

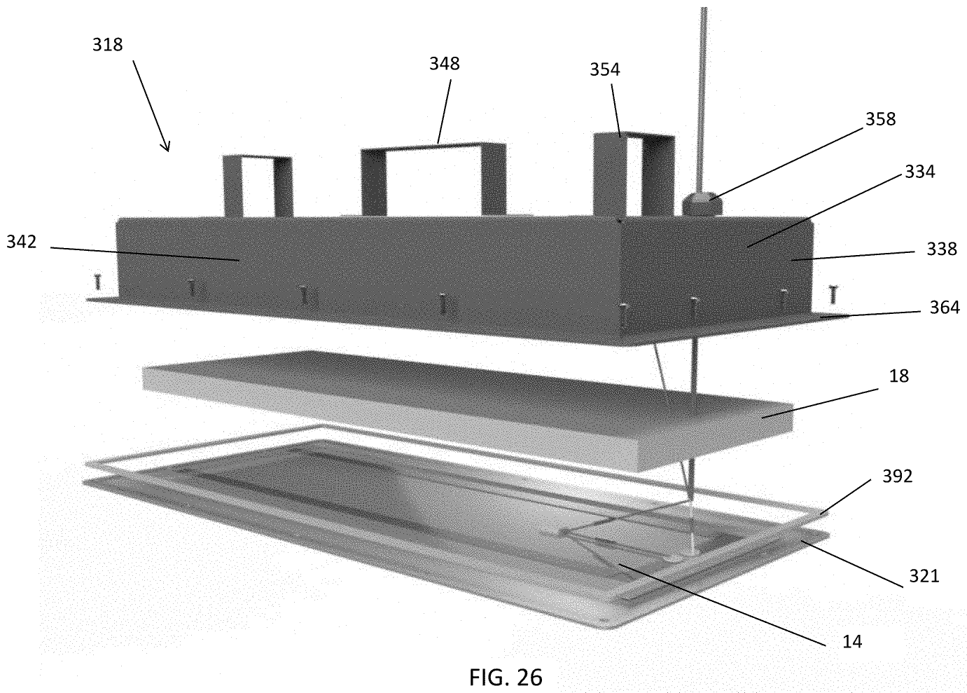

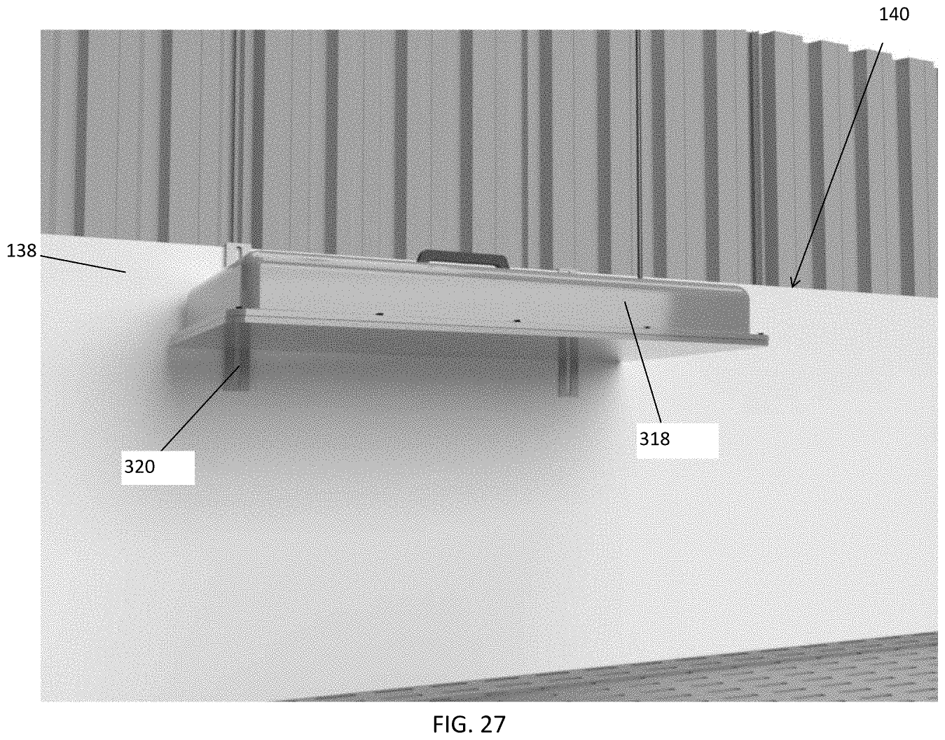

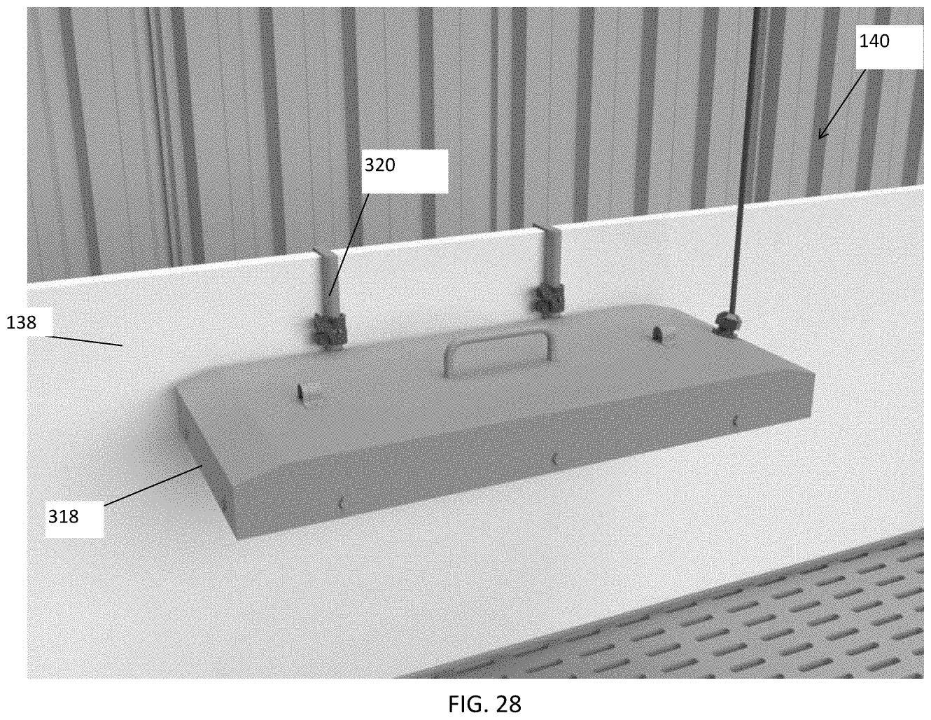

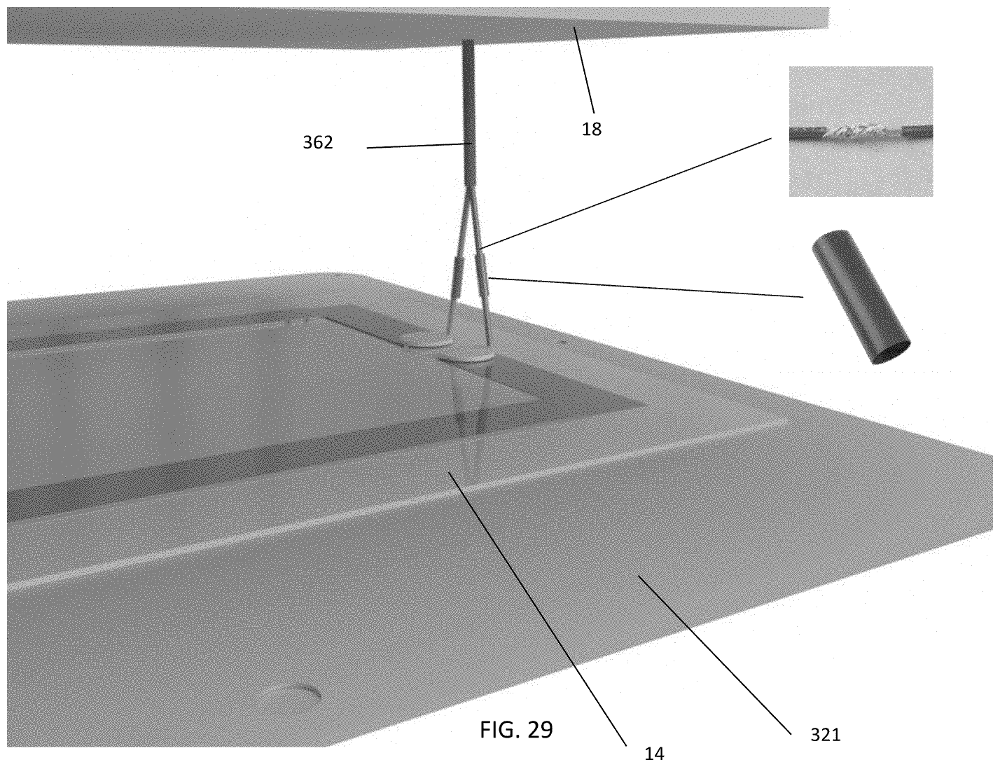

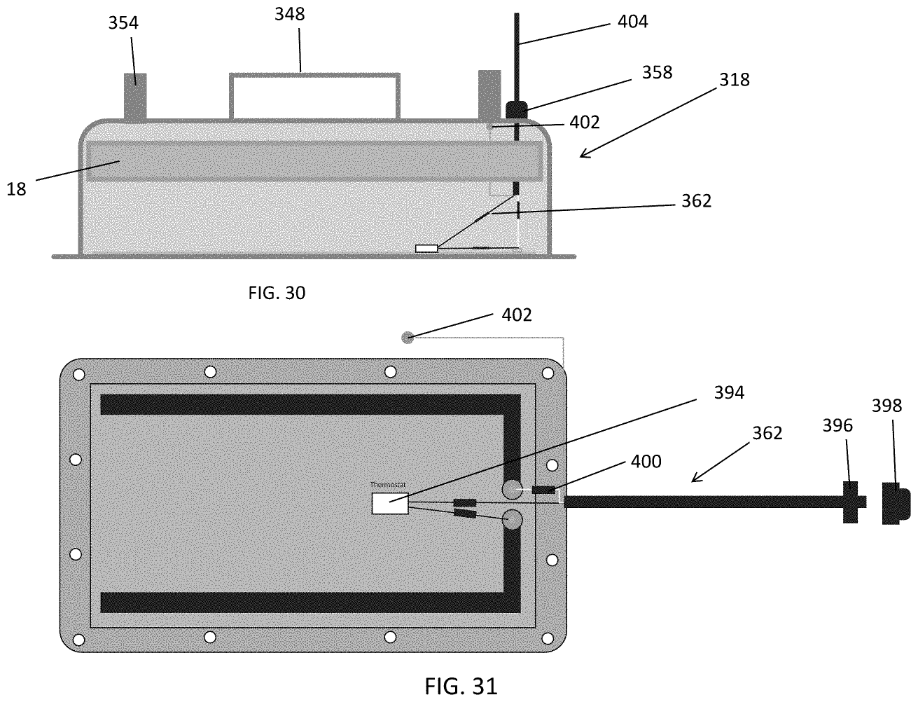

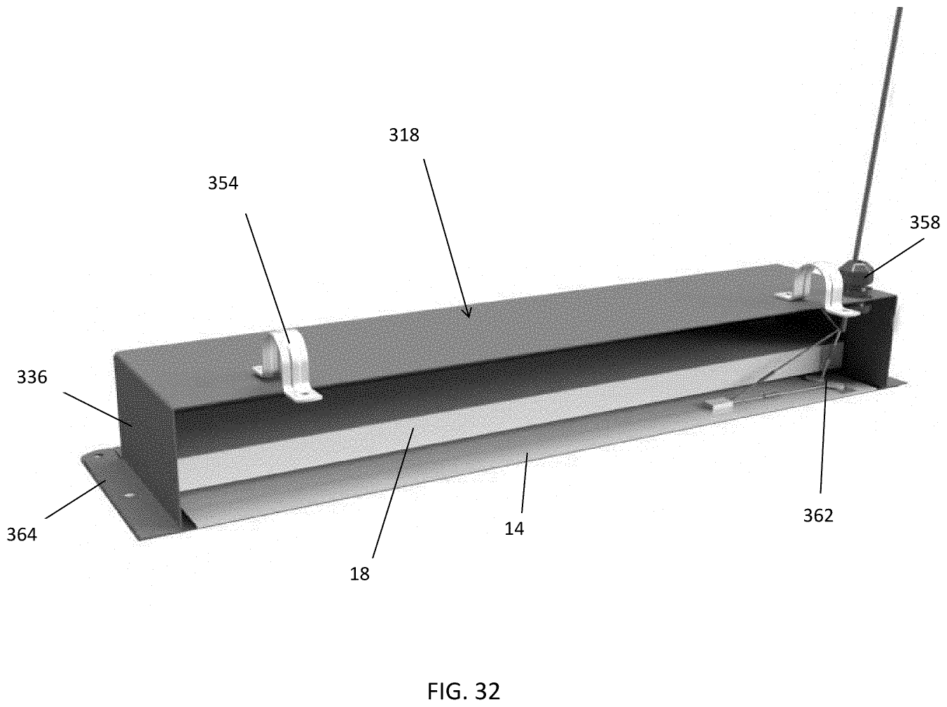

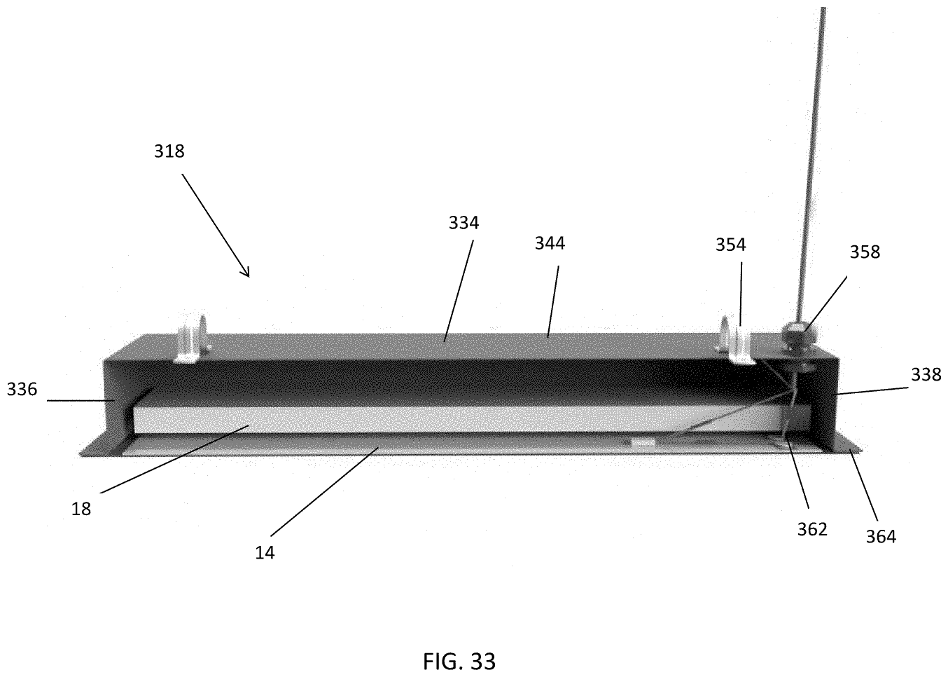

With reference to FIGS. 17-33 one or more alternative arrangements of system 10 are presented. The arrangement(s) discussed with reference to FIGS. 17-33 are similar to the system 10 described with reference to FIGS. 1-16 and as such the disclosure related to the arrangement(s) shown in FIGS. 1-16 applies to the arrangement(s) shown in FIGS. 17-33 unless stated specifically herein. The system 10 discussed with reference to FIGS. 17-33 is similar to the system 10 discussed with reference to FIGS. 1-16 with one primary difference relating to the use of separate housings 318 of the heating panels 12, which may be use together or separately.

### System 10:

In the arrangement shown, as one example, system 10 may be formed of any suitable size, shape and design and is configured to generate and direct heat downward when operated to facilitate, for example, care of livestock. In one or more arrangements shown, as one example, system 10 includes a pair of housing 318, a pair of heating panels 12 positioned within the housings 318, and optionally a bracket assembly 366 to facilitate connecting and/or mounting of the housings 318 as a pair, among other components.

### Heating Panel(s) 12:

Heating Panels 12 are formed of any suitable size, shape, and design and are configured to generate radiant heat and facilitate connection with housing 318. In the arrangement shown, as one example, heating panels 12 each include a diffusion plate 321, a heating layer 14, a radiant barrier 16, an insulating member 18, and an optional frame 322, among other components.

### Frame 322:

In one or more arrangements, frame 322 is formed of any suitable size, shape, and design and is configured to create space between radiant barrier 16 and heating layer 14 and facilitate connection of radiant barrier 16 and heating layer 14 with housing 318. In the arrangement shown, as one example, frame 322 includes three support arches 324, and a cross bar 333, among other components.

### Support Arch 324:

In one or more arrangements support arch 324 is formed of any suitable size, shape, and design and is configured to create space between radiant barrier 16 and heating layer 14 in addition to facilitating a connection to radiant barrier 16. In the arrangement shown, as one example, support arch 324 includes a base 326, pair of legs 328 attached to base 326, pair of feet 330 attached to the two legs 328, and a support beam 332, which connects the two legs 328 below the base 326. Support beam 332 is configured to facilitate connection of support arch 324 to cross bar 333 of frame 322.

In some various different arrangements, support arch 324 may be connected to cross bar 333 or other portion of frame 322 using various means and methods known in the art including but not limited to, for example, adhesive bonding, chemical bonding, welding, and/or mechanical attachment means such as screws, bolts, threading, interlocks, clips, pins, or other coupling devices.

### Housings 318:

In one or more arrangements, system 10 includes housings that may be used separately or connected together as a pair. Housings 318 are formed of any suitable size, shape, and design, and are configured to operably connect with and hold one or more heating panel(s) 12 in position for downward directed heating of livestock. In this example arrangement, each housing 318 has generally rectangular shaped main body 334 having a front wall 336, a rear wall 338, a left side 340, a right side 342, a top 344, and an open bottom 346. In some various arrangements, top 344 may have angled edges 348 adjacent the front wall 336 and rear wall 338.

In some various arrangements, housings 318 may be formed of various different materials. In one or more arrangements shown, housings 318 are formed of thermoplastic polyolefin. However, the embodiments are not so limited. Rather, it is contemplated that in one or more arrangements, housings 318 may be formed of various materials including but not limited to, for example, thermoplastic polyolefin or other plastic, metal, ceramics composites, and/or any other suitable material.

### Handle 348:

In this example arrangement, each housing 318 includes a handle 348 located in a central position on the top 344 of each housing 318. Handle 348 is formed of any suitable size, shape, and design, and is configured to operably connect with each housing 318 and to facilitate lifting of system 10. In this example arrangement, handle 348 is generally U-shaped and includes a top member 350 and a pair of legs 352. However, the arrangements are not so limited. Rather, it is contemplated some various arrangements may utilize various types of knobs, loops, or built-in gripping mechanisms known in the art to facilitate raising and lowering of system 10.

### Fasteners 354:

In this example arrangement, each housing 318 includes a pair of fasteners 354 located on the top 344 of each housing 318 adjacent the front wall 336 and the rear wall 338. Fasteners 354 are generally U-shaped and have a pair of feet 356 configured to facilitate connection to the top 344 of housing 318. Fasteners 354 are configured to facilitate suspension of system 10 through the use of a chain. However, the arrangements are not so limited. Rather, it is contemplated some various arrangements may utilize rope, cables, wires, cord, string or other suspension mechanisms known in the art to facilitate hanging system 10.

### Cable Gland 358:

In this example arrangement, system 10 includes a pair of housings 318 with one of the housing 318 having a cable gland 358. Cable gland 358 is formed of any suitable size, shape, and design and is configured to attach and secure electrical wiring 362 to and from heating layer 14 and provide a seal (e.g., a waterproof seal) around the wiring 362. In the arrangement as shown, as one example, cable gland 358 is sized and shaped to receive electrical wiring 362 connected to a power source 360, which delivers power to the heating layer 14.

### Flange 364:

In this example arrangement, each housing 318 of the pair of housing 318 includes a flange 364. Flange 364 is formed of any suitable size, shape, and design, and is configured to receive and operably connect diffusion plate 321 to housing 318. In the arrangement as shown, as one example, flange 364 is generally rectangular in shape and is configured to line the edge of each housing 318 of the pair of housing 318.

### Bracket Assembly 366:

In addition to or in lieu of fasteners, in one or more arrangements, system 10 includes a bracket assembly 366 operably connected to the housings 318. Bracket assembly 366 is formed of any suitable size, shape, and design, and is configured to connect with housings 318 and facilitate mounting of housings 318 over a top edge of a wall 138 between two livestock stalls 140. In the arrangement as shown, as one example, bracket assembly 366 includes a pair of bracket hangers 368 and connecting members 374.

### Bracket Hangers 368:

Bracket hangers 368 are formed of any suitable size, shape, and design, and are configured to fit over a top of wall 138 and operably connect with connecting members 374 to facilitate mounting of housings 318 therefrom. In the arrangement shown, as one example, bracket hangers have an inverted U shape formed by a base 370 and a pair of legs 372. In this example arrangement, base has an elongated generally rectangular shape configured to extend across the top of wall 138. In this arrangement, as an example, the legs 372 of the bracket hangers 368 have an elongated cylindrical shape extending downward from an upper end 372a, where legs 372 connect with opposing ends of the base 370, to respective lower ends 372b.

### Connecting Members 374:

Connecting members 374 are formed of any suitable size, shape, and design, and are configured to connect with legs 372 of bracket hangers 368. In the arrangement shown, connecting members 374 are attached to a side 340/342 of a housing 318 have an elongated cylindrical tube shape extending vertically from an upper end 374a to a lower end 374b. In some various different arrangements, connecting members 374 may be connected to housing 318 using various means and methods known in the art including but not limited to, for example, adhesive bonding, chemical bonding, welding, and/or mechanical attachment means such as clamps, clips, pins, cotters, screws, bolts, fasteners, interlocks, rings, or, or any other securing mechanisms.

In this example arrangement, connecting members 374 are configured to receive lower end 372b of a leg 372 into upper end 274a and fit around each leg 372 of the leg 372 to facilitate connection wherewith. In this example arrangement, connecting members 374 can be moved upward and downward along legs 372 and then secured in place to adjust the height at which housings 318 are mounted relative to the top of wall 138.

In the arrangement, shown, connecting members 374 are secured in place at a desired position along legs 372 by a plurality of clamps 376 positioned on an outer surface of connecting members 374. In this example arrangement, connecting members 374 have a slit 374c extending vertically between upper end 374a and lower end 374b to permit circumference of the tube shape to be expanded and/or contracted to securely hold legs 372 with close and tight tolerances. In this example arrangement, clamps 374 may be tightened to cause the tube shape of connection members 374 to contract and clamp onto legs 372.

However, the arrangements are not so limited. Rather, it is contemplated some various arrangements may utilize various methods or means known in the art to facilitate securing connecting members 374 in place around each leg 372 including but not limited to, for example, adhesive bonding, chemical bonding, welding, and/or mechanical attachment means such as clamps, clips, pins, cotters, screws, bolts, fasteners, interlocks, rings, or any other securing mechanisms.

### Thermostat 394:

In one or more arrangements, system 10 includes one or more thermostats to regulate heat generation. For example, in one or more arrangements, system 10 includes a thermostat 394 positioned on heating layer 14. Thermostat 394 is formed of any suitable size, shape, or design, and is configured to regulate power provided to heating layer 14 based on temperature of the heating layer 14, for example, to ensure heating layer does not exceed a safe operation range. For instance, in one or more arrangements, thermostat 394 is configured to prevent heating layer from operating above a threshold of 302 F (above which heading layer 14 materials may become damaged. Additionally or alternatively, system may include a thermostat to maintain a temperature set by a user.

### Alternative Arrangement(S):

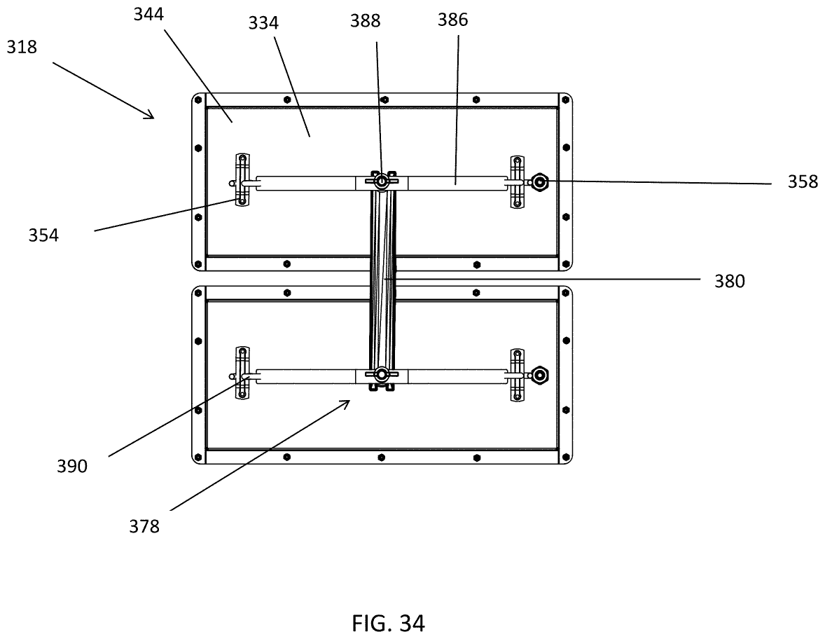

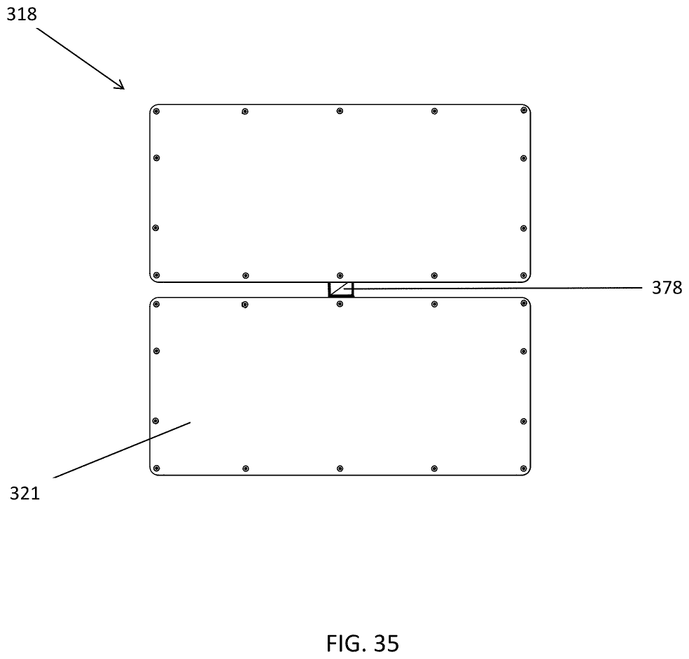

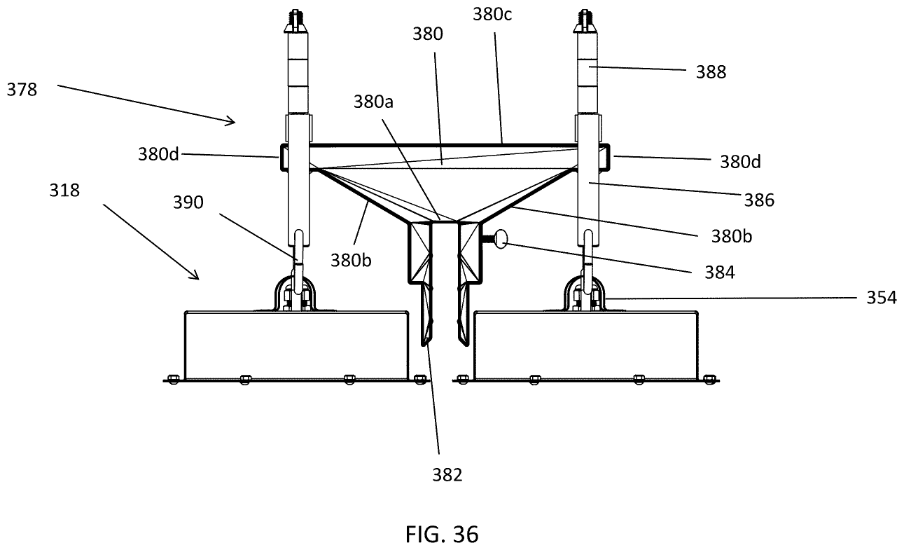

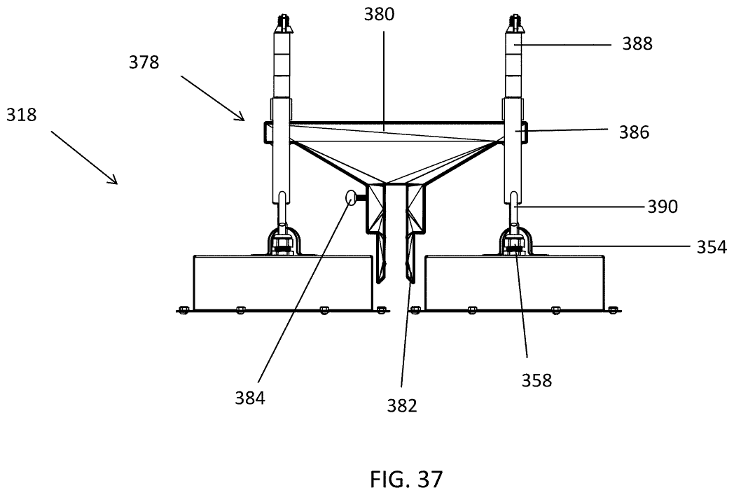

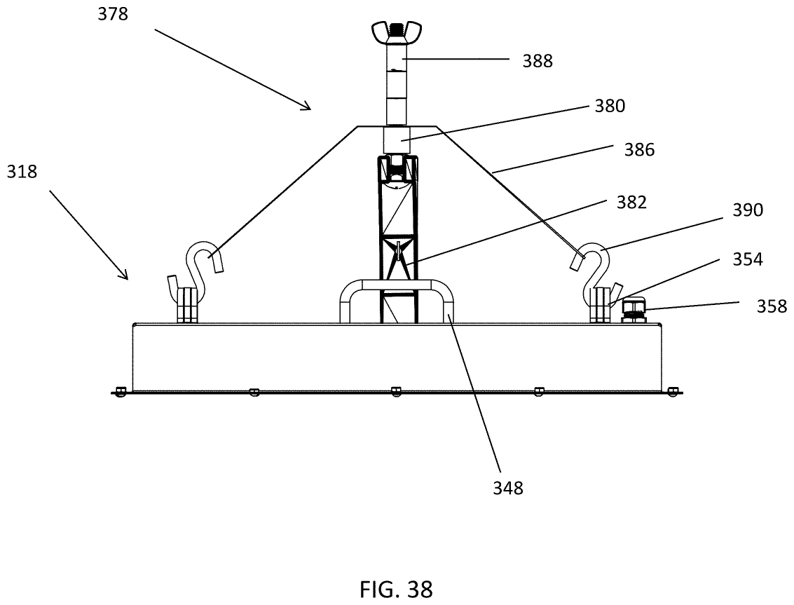

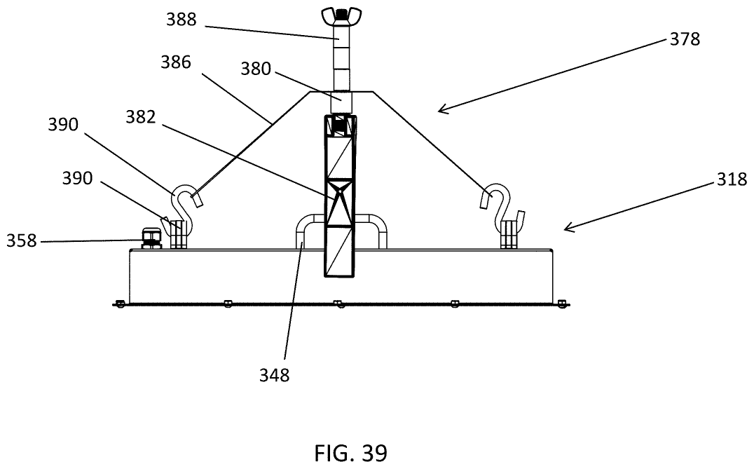

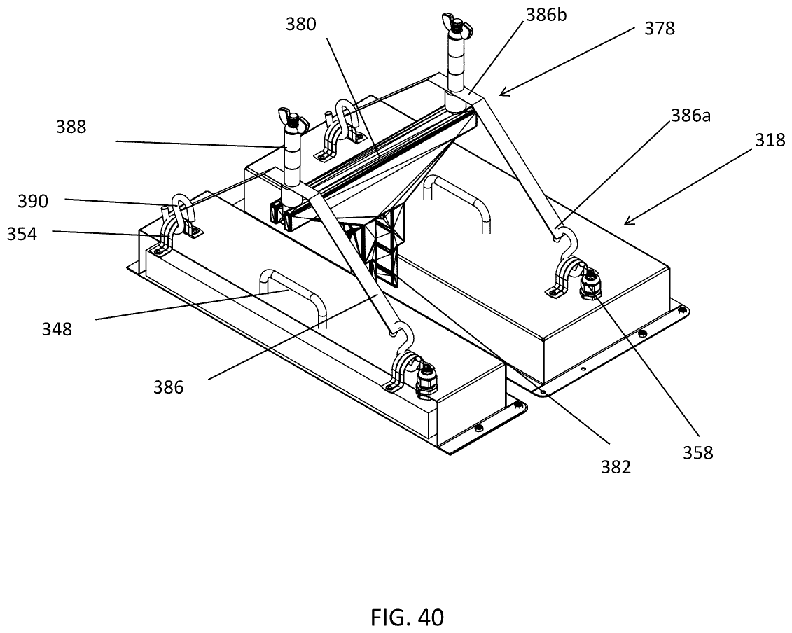

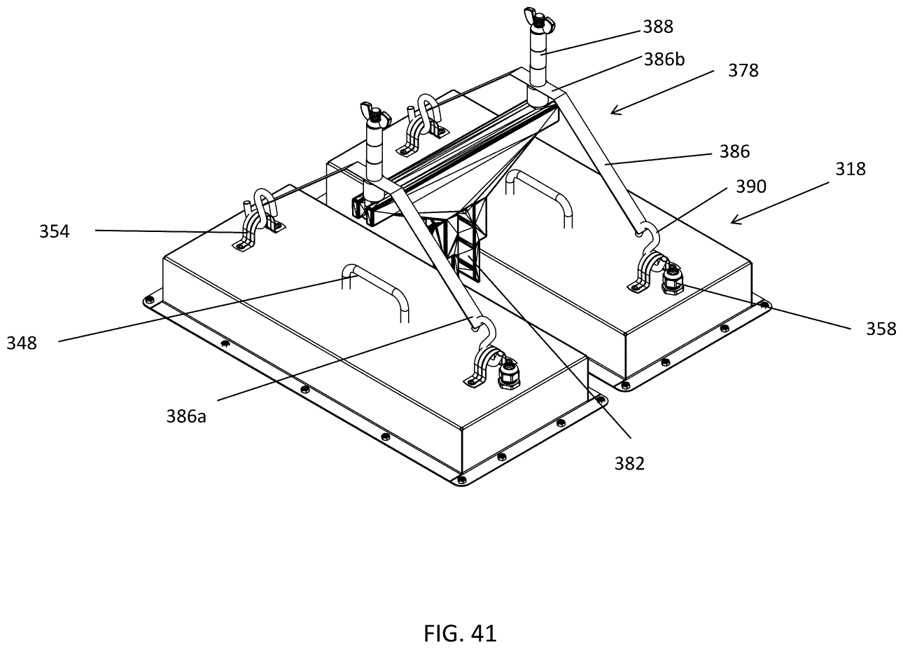

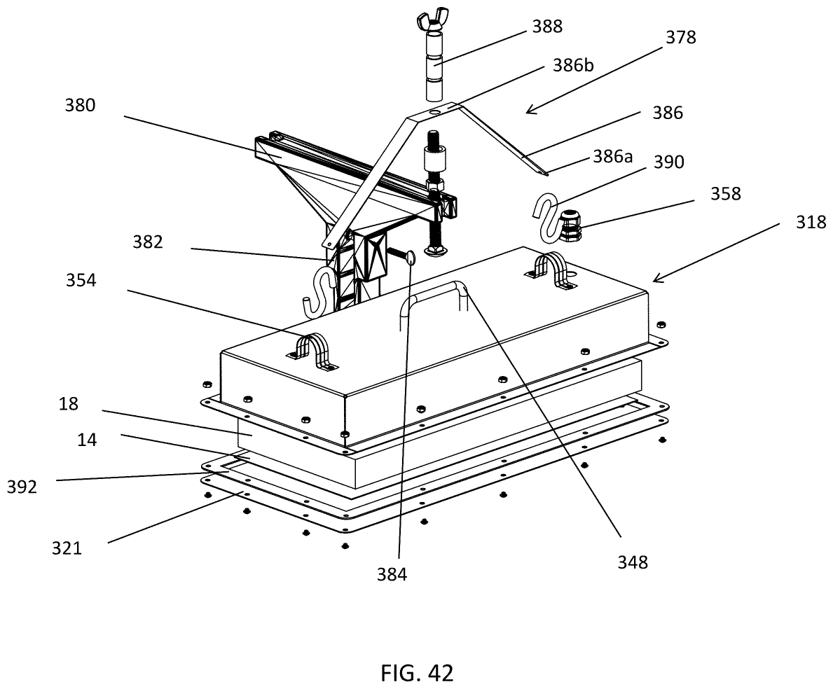

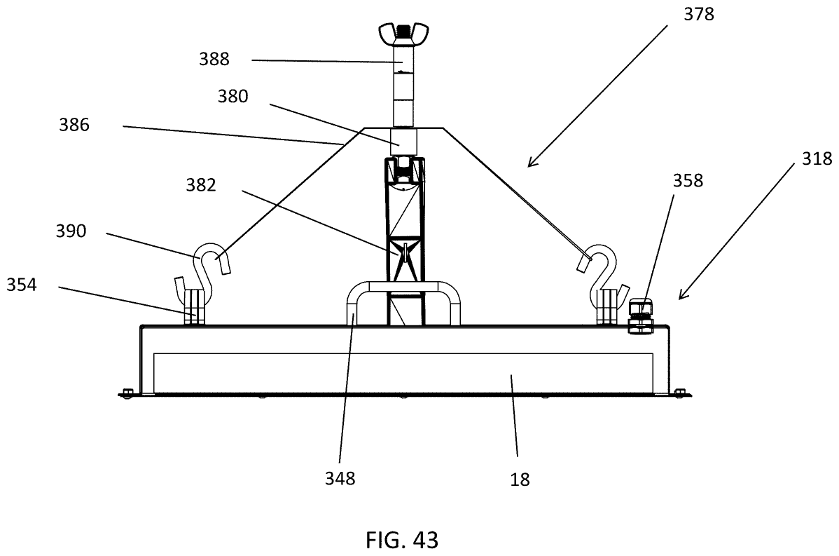

With reference to FIGS. 34-43 one or more alternative arrangements of system 10 is presented. The arrangement(s) shown in FIGS. 34-43 is similar to the system 10 discussed with reference to FIGS. 1-16 and system 10 discussed with reference to FIGS. 17-33, as such the disclosures related to the arrangements shown in FIGS. 1-16 and FIGS. 17-33 apply to the arrangement shown in FIGS. 34-43 unless stated specifically herein. The system 10 discussed with reference to FIGS. 34-43 is particularly similar to the system 10 discussed with reference to FIGS. 17-33 with one primary difference relating to the bracket assembly used to connect a pair of housings 318 together and/or mount the pair of housings 318.

### Bracket Assembly 378:

In one or more arrangements, system 10 includes a bracket assembly 378 operably connected to the housings 318. Bracket assembly 378 is formed of any suitable size, shape, and design, and is configured to connect with housings 318 and mount housings 318 over a top edge of a wall 138 between two livestock stalls 140. In the arrangement as shown, as one example, bracket assembly 378 is configured to connect fit over a tope of wall 138 and facilitate suspension of housings 318 therefrom (e.g., with chains, links, hooks, cables, rope, cord, and/or other means for hanging. In this example arrangement, bracket assembly 378 includes a base 380 with a pair of legs 382 and a pair of support beams 386, among other components.

### Base 380:

Base 380 is formed of any suitable size, shape, and design, and is configured to fit over a top of wall 138 and operably connect with support beams 386 to facilitate mounting of housings 318 therefrom. In the arrangement shown, as one example, base has a generally isosceles trapezoidal shape having a bottom 380a configured to extend across wall 138 between opposing sides 380b. In this example arrangement, opposing sides 380b of base 380 extend outward to the sides and upward from bottom 380a to a top 380c.

### Legs 382:

Legs 382 are formed of any suitable size, shape, and design, and are configured to fit on either side of wall 138 and secure base in place when installed. In the arrangement shown, as one example, legs 382 are generally in an upside down L-shape and extend downward from bottom 380a of base 380 proximate to opposing sides 380b. In the arrangement shown, the top 380c of base 380 extends outward to the sides of wall 138 to opposing outer ends 380d. In this example arrangement, base 380 operates as a cantilever to hang support beams from outer ends 380d of base 380.

In some arrangements, bracket assembly 378 may be configured to be held in place on top of wall 138 by gravity and/or friction. Additionally or alternatively, in some arrangements bracket assembly 378 may be secured in place on wall 138 (e.g., by fasteners). In this example arrangement, legs 382 have a hole to receive a fastener 384 which helps facilitate close and tight tolerances between legs 382 and wall 138. However, the arrangements are not so limited. Rather, it is contemplated some various arrangements may use various methods or means known in the art to facilitate securing base 380, legs 382, and/or other portion of bracket assembly 378 to wall 138 including but not limited to, for example, adhesive bonding, chemical bonding, welding, and/or mechanical attachment means such as clamps, clips, pins, cotters, screws, bolts, fasteners, interlocks, rings, or any other securing mechanisms. Support beams 386 are formed of any suitable size, shape, and design, and are configured to operably connect with base 380 to facilitate mounting of housings 318. In the arrangement shown, as one example, support beams 386 form a generally triangular shape with opposable ends 386a and are configured to connect to base 380 at the apex 387 of support beams 386 by fasteners 388. Support beams 386 are also configured to connect to the housings 318 at opposable ends 386a. Opposable ends 386a are configured to receive hooks 390. Hooks 390 are formed of any suitable size, shape, and design, and are configured to loop through the fasteners 354 of the housings 318 to facilitate engagement between support beams 386 and housings 318. Hooks 390 are generally S-shaped and loop through fasteners 354 at one end and holes in the opposable ends 386a of support beams 386 at the other end. However, again, the arrangements are not so limited. Rather, it is contemplated some various arrangements may utilize clamps, pins, cotters, fasteners, rings, or other securing mechanisms known in the art to facilitate connection of support beams to the top of housing.

### In Operation:

As an illustrative example, during assembly of system 10, heating layer 14 is affixed to the center of base plate 321 by an adhesive. Similarly, a thermostat 394 is affixed to the center of the heating layer 14 by an adhesive. A neutral wire 400 is spliced and soldered to the lead on the heating layer 14. An epoxy layer is applied to solder points for potting. A ground wire 402 is slid through a hole in the insulating layer 18. The ground wire 402 is then soldered to the interior enclosure. A power cord 404 is slid through the insulating layer and the bottom component 396 of the cable gland is installed. The insulating layer 18 is then pressed firmly into the housing 318 to be held in place. A gasket 392 is pressed between the housing 318 and the diffusion plate 321 and nuts or bolts are installed around the exterior to firmly compress the gasket 392. The top component 398 of the cable gland is then slid over the power cord 404 and secured in place.

What is claimed:

1. A heating system, comprising:
a housing;
the housing having a hollow interior with an open lower end;
a first heating panel positioned in the open lower end of the housing;
wherein the first heating panel includes a heating layer;
the heating layer including a conductive microfilm;
a first electrical contact connected to the conductive microfilm;
a second electrical contact connect to the conductive microfilm;
wherein application of a voltage difference between the first electrical contact and the second electrical contact causes current to flow through the conductive microfilm, thereby generating heat.

2. The system of claim 1, wherein the conductive microfilm includes a layer of graphene.

3. The system of claim 1, wherein the conductive microfilm includes a layer of nano-carbon fiber material.

4. The system of claim 1, wherein the conductive microfilm includes a carbon silver nanomaterial mixture.

5. The system of claim 1, wherein the conductive microfilm has a honey-comb pattern.

6. The system of claim 1, wherein the conductive microfilm is self-healing.

7. The system of claim 1, wherein the heating layer includes an upper substrate layer and a lower substrate layer;
wherein the conductive microfilm is positioned between the upper substrate layer and the lower substrate layer.

8. The system of claim 1, wherein the first heating panel includes a radiant barrier positioned above the heating layer.

9. The system of claim 1, further comprising a second heating panel positioned in the open lower end of the housing;
wherein the housing is configured to attach on top of a wall between a pair of livestock stalls;
wherein the first heating panel is positioned to heat a first one of the pair of livestock stalls;
wherein the second heating panel is positioned to heat a second one of the pair of livestock stalls.

10. The system of claim 1, further comprising a second heating panel positioned in the open lower end of the housing;
wherein the housing is configured to attach on top of a wall between a pair of livestock stalls;
wherein the first heating panel is positioned to heat a first one of the pair of livestock stalls;
wherein the second heating panel is positioned to heat a second one of the pair of livestock stalls;
wherein the first heating panel and the second heating panel adjustable to generate different amounts of heat.

11. The system of claim 1, wherein when current flows through the conductive microfilm the conductive microfilm emits infrared radiation.

12. The system of claim 1, further comprising an insulating material positioned within the hollow interior of the housing above the first heating panel.

13. A heating system, comprising:
a housing;
the housing having a first heating panel;
wherein the first heating panel includes a conductive microfilm;
wherein conductive microfilm includes a layer of graphene;
wherein when power is applied to the layer of graphene, the layer of graphene generates heat.

14. The system of claim 13, further comprising:
a first electrical contact connected to a first side of the conductive microfilm;
a second electrical contact connect to a second side of the conductive microfilm;
wherein application of a voltage difference between the first electrical contact and the second electrical contact causes current to flow through the conductive microfilm, thereby generating heat.

15. The system of claim 13, wherein the conductive microfilm has a honey-comb pattern.

16. The system of claim 13, wherein the conductive microfilm is self-healing.

17. The system of claim 13, wherein the first heating panel includes an upper substrate layer and a lower substrate layer;
wherein the conductive microfilm is positioned between the upper substrate layer and the lower substrate layer.

18. The system of claim 13, wherein the first heating panel includes a radiant barrier positioned above a heating layer.

19. The system of claim 13, further comprising a second heating panel;
wherein the housing is configured to attach on top of a wall between a pair of livestock stalls;
wherein the first heating panel is positioned to heat a first one of the pair of livestock stalls;
wherein the second heating panel is positioned to heat a second one of the pair of livestock stalls.

20. The system of claim 13, further comprising a second heating panel;
wherein the housing is configured to attach on top of a wall between a pair of livestock stalls;
wherein the first heating panel is positioned to heat a first one of the pair of livestock stalls;
wherein the second heating panel is positioned to heat a second one of the pair of livestock stalls;
wherein the first heating panel and the second heating panel adjustable to generate different amounts of heat.

21. The system of claim 13, wherein when current flows through the conductive microfilm the conductive microfilm emits infrared radiation.

22. The system of claim 13, further comprising an insulating material positioned within a hollow interior of the housing above the first heating panel.

23. A method, comprising:
providing a heating system having a housing and a first heating panel;
the housing having a hollow interior with an open lower end;
the first heating panel positioned in the open lower end of the housing;
wherein the first heating panel includes a heating layer;
the heating layer including a conductive microfilm;
a first electrical contact connected to the conductive microfilm;
a second electrical contact connect to the conductive microfilm;
generating heat by applying a voltage difference between the first electrical contact and the second electrical to cause current to flow through the conductive microfilm, thereby generating heat.

24. The method of claim 23, wherein the conductive microfilm includes a layer of graphene.

25. The method of claim 23, wherein the conductive microfilm includes a layer of nano-carbon fiber material.

26. The method of claim 23, wherein the conductive microfilm includes a carbon silver nanomaterial mixture.

27. The method of claim 23, wherein the conductive microfilm has a honey-comb pattern.

28. The method of claim 23, wherein the conductive microfilm is self-healing.

29. The method of claim 23, wherein the heating layer includes an upper substrate layer and a lower substrate layer;
wherein the conductive microfilm is positioned between the upper substrate layer and the lower substrate layer.

30. The method of claim 23, wherein the first heating panel includes a radiant barrier positioned above the heating layer.

31. The method of claim 23, further comprising a second heating panel positioned in the open lower end of the housing;
wherein the housing is configured to attach on top of a wall between a pair of livestock stalls;
wherein the first heating panel is positioned to heat a first one of the pair of livestock stalls;
wherein the second heating panel is positioned to heat a second one of the pair of livestock stalls.

32. The method of claim 23, further comprising a second heating panel positioned in the open lower end of the housing;
wherein the housing is configured to attach on top of a wall between a pair of livestock stalls;
wherein the first heating panel is positioned to heat a first one of the pair of livestock stalls;
wherein the second heating panel is positioned to heat a second one of the pair of livestock stalls;
wherein the first heating panel and the second heating panel adjustable to generate different amounts of heat.

33. The method of claim 23, wherein current to flow through the conductive microfilm causes the conductive microfilm to emit infrared radiation.
